(19) United States
(12) Patent Application Publication
(10) Pub. No.: US 2009/0185905 A1
(43) Pub. Date: Jul. 23, 2009

(54) RETURN AND LIMITED MOTION IN ENERGY CAPTURE DEVICES

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/299,314

(22) PCT Filed: Apr. 29, 2007
(86) PCT No.: PCT/IL07/00523

§ 371 Date: Nov. 3, 2008

Related U.S. Application Data
(60) Provisional application No. 60/746,375, filed on May 4, 2006.
(60) Provisional application No. 60/805,875, filed on Jun. 27, 2006.
(60) Provisional application No. 60/807,489, filed on Jul. 16, 2006.
(60) Provisional application No. 60/826,927, filed on Sep. 26, 2006.
(60) Provisional application No. 60/866,070, filed on Nov. 16, 2006.
(60) Provisional application No. 60/908,693, filed on Mar. 29, 2007.

(51) Int. Cl. F03D 3/06; F03B 13/00

(52) U.S. Cl. 416/131; 290/54

(57) ABSTRACT

The problems of return and continuous motion are common to a number of renewable energy machines, particularly in applications with wind and magnetism. Devices are presented for obtaining wind and other energy through the use of sails and other components with flexible structures on a rigid frame that require a return motion. Other devices presented enable the capture of linear energy, such as that of wind, with or without return motion, or at least minimizing such motion, with or without the use of blades.

### FIELD AND BACKGROUND OF THE INVENTION

The present invention relates to systems, devices, and methods for capturing renewable energy, such as wind, and for turning that energy into electrical energy.

Sources of renewable energy have been widely sought after, and wind energy is one of them. Problems of current art wind blade turbines include the following:
Failure to capture a large portion of the mass flow energy in the wind, because of separations both between the blades and between the turbines
Sharp moving parts, dangerous to humans and birds
Difficult maintenance
Large amounts of vibration, noise, and materials stress
High cost
Need to support a generator mechanism at heights sometimes over 100 meters
Heavy blades that require substantial wind speed before they start turning

The present invention first describes systems, devices, and methods of obtaining energy from wind using sails. The advantage of using blades is that there is no issue of how to return the energy capture structure to the starting point to capture more energy, as there is with sails and other structures that can move linearly or present a large linear face to the energy flow. The current invention presents several solutions to this issue, particularly in wind and magnetism, with and without the use of blades.

Various attempts have been made to solve the problems of converting wind energy into electrical energy, and none, including vertical blade turbines and foils, have been found to address the enhancements of the current invention. There is thus a widely recognized need for, and it would be highly advantageous to have, a more efficient and cheaper method of obtaining energy from wind.

U.S. Pat. No. 6,992,402 discloses the use of a sail moving and returning along a long track to create electric energy. This is different from the current invention's use of limited motion. U.S. Pat. No. 4,447,738 uses air compressed from propeller blades, not the device of compression of the current invention.

The current invention presents a unique set of solutions for taking advantage of linear force in several types of renewable energy machines. Some solutions confine most of the movement to a small, internal area.

There is thus a widely recognized need for, and it would be highly advantageous to have, a set of solutions that would make energy capture safer and more readily available.

### BRIEF DESCRIPTION OF THE DRAWINGS

The invention is herein described, by way of example only, with reference to the accompanying drawings, wherein:

FIG. 1 is a vertical axis sail system.

FIG. 2 is a diagram of how a vertical axis sail system would work.

FIG. 3 is a diagram of the sail moving system of a vertical axis sail system.

FIG. 4 is a diagram of a single sail and crankshaft.

FIG. 5 is a diagram of two sails and a crankshaft.

FIG. 6 is a diagram of a directionally self-adjusting sail system.

FIG. 7 is a diagram of a directionally self-adjusting sail system with a wind deflection object.

FIG. 8 is a diagram of a directionally self-adjusting sail system with an additional sail attached to the exterior sail.

FIG. 9 is a superior view of a self-adjusting sail.

FIG. 10 is a diagram of retractable paddle wheels.

FIG. 11 is a diagram of a horizontal axis retractable sail system.

FIG. 12 is a diagram of a blade with a peripheral extension.

FIG. 13 is a diagram of a blade or paddle with a flexible interior.

FIG. 14 is a diagram of sail extensions to a blade.

FIG. 15 is a diagram of the basic components of a linear motion sail turbine.

FIG. 16 is a 3D diagram of one configuration of a linear motion sail turbine.

FIG. 17 shows some configurations for sails for a linear motion sail turbine.

FIG. 18 shows a configuration for a sail for a linear motion sail turbine.

FIG. 19 shows a building block sail for sails for a linear motion sail turbine.

FIG. 20 is a conceptual outline of a piezoelectric component for a linear motion sail turbine.

FIG. 21 is a Thermosail flow chart.

FIG. 22 is a Magnetosail outline.

FIG. 23 is a diagram of arrays and bidirectionality.

FIG. 24 is a diagram of the use of compressed air for electricity generation.

FIG. 25 is a chart of power from a thermal system.

FIG. 26 shows two diagrams of a Bourdon Tube.

FIG. 27 is a diagram of a paneled device hanging like a pendulum.

FIG. 28 is two 3-D views of a magnetoclamp.

FIG. 29 is a 3-D view of a magnetoclamp with a rotor and a coil.

FIG. 30 shows overlap in the magnetoclamp concept.

FIG. 31 is a view of one kind of magnetoclamp sandwich.

FIG. 32 is a diagram of the details of a magnetoclamp with repulsion and shielding.

FIG. 33 is a diagram of another way of constructing a magnetoclamp.

FIG. 34 is a diagram of a parallel array of magnetoclamps.

FIG. 35 is a diagram of use of a magnetic generator that makes use of gravity.

FIG. 36 is a diagram of a magnetoclamp oriented to make use of gravity.

FIG. 37 is a diagram of a magnetic generator with weights.

FIG. 38 is a horizontal cross-section of a magnetic generator box.

FIG. 39 is a diagram of the orientation of the magnet sets.

FIG. 40 is a diagram of a sail and compression chamber with inlet and outlet valves.

FIG. 41 is a diagram of a piezoelectric rattle.

### DESCRIPTION OF THE PREFERRED EMBODIMENTS

The present invention is of a set of solutions to the problem of building a renewable energy or other machine that requires, or apparently requires, return or limited motion.

The principles and operation of these solutions, particularly in wind and magnetism, according to the present invention, may be better understood with reference to the drawings and the accompanying description.

Definitions: For convenience here, the term “horizontal” refers to an x-axis and “vertical” to a y-axis in any orientation. “Inferior” and “superior” may refer to a y-axis orientation without one object necessarily being higher than the other. Motion with propeller blades is for the purpose of this patent mostly considered “vertical” because of the lift component, although there is also some horizontal force. “Wind” is the major focus of this invention, but it is interchangeable with any fluid. When “fluid” is used here, it can refer to wind, water, and other substances usually included in the hydrodynamic use of “fluid.” A “sail” is any panel of any material whose purpose is to capture a flow, wherein at least part of one of the materials capturing the flow is soft or light relative to the rest of the machine. A “flow deflection device” is a structure that directs the velocity of the fluid flow into the energy capture portion of the system. It is usually an aerodynamic shape. The shape of a “clamp” is defined as being two layers substantially in parallel with a separation in the middle. A “return journey” or “return trip” refers to the path required for a structure involved in capturing energy to return to the point where it can capture energy again.

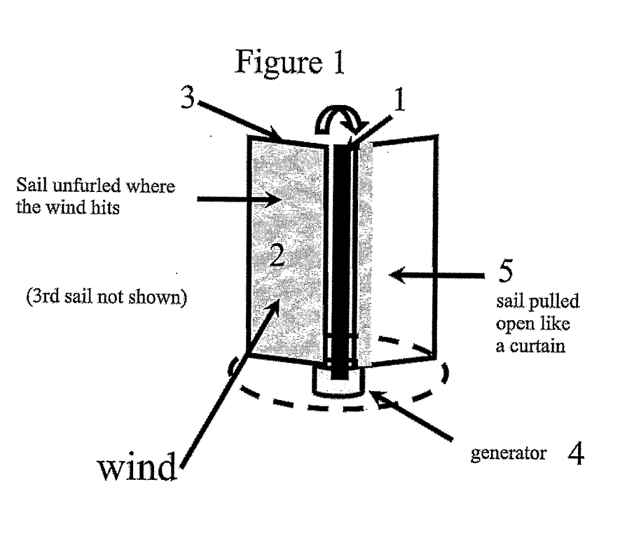

Referring now to the drawings, FIG. 1 illustrates the concept of a vertical axis sail according to the current invention. Part (1) is a vertical rod providing a central attachment point for at least one sail (2). The vertical rod (1) is attached at its bottom to a generator (4) that is attached directly or indirectly to the ground or other anchoring point and spins within the generator. The generator (4) can be any of the group of generators well known in the art to create electricity from the spinning of the central rod. The central rod (1), or rods attached in parallel to it performing the same function of a central attachment point, connect to side extension rods (3) with an optional outside vertical bar. The sail (2) furls and unfurls using means attached to the side extension rods. The sail is rectangular in the ideal embodiment, although it can have other shapes, such as a triangle, that may not work as well. In one embodiment, the furling and unfurling of the sail can be accomplished by means of a curtain drawing type of mechanism, of which there are several. The current invention allows for other means for devices to accomplish this action. The diagram illustrates that an unfurled sail absorbs wind energy as it rotates and returns to its original position furled (5) to avoid the wind on its return journey.

The dotted line in FIG. 1 indicates the horizontal extent of the sail system. It is recommended that a barrier for safety purposes be built at that point in one embodiment. Additionally, a horizontal surface underneath the sails could provide a support for the periphery of the sails by means of a smooth runway for sliding means attached to the bottom of each sail. An example would be magnetic ball bearings. This is shown later in part (16).

In another embodiment, there may be more than one sail attached to the central rod, and each sail may be composed of several smaller sails all in a similar radial and vertical orientation.

Various control means may be used to ensure that the sail furls and unfurls at the correct point. They may be controlled electronically to furl and unfurl at set angles that depend on the number of sails and/or on the wind direction.

The ideal method of a sensor/control device for the system is to

1. Determine the wind direction with a monitoring device

2. Set the point on the system when each sail is furled and unfurled

A sensor/control device would have an electrical or other connection to the system. Other ways of accomplishing this are possible.

In all cases, the sail's upper and lower electronic control and drawing means will be coordinated in order to pull the upper and lower margins of the sail to and from substantially the same horizontal point simultaneously.

In another embodiment, multiple vertical or horizontal foils, ideally semi-rigid, could be used as sails. (We are including in the definition of sails any structure broad enough to capture wind, but not a rigid propeller blade.)

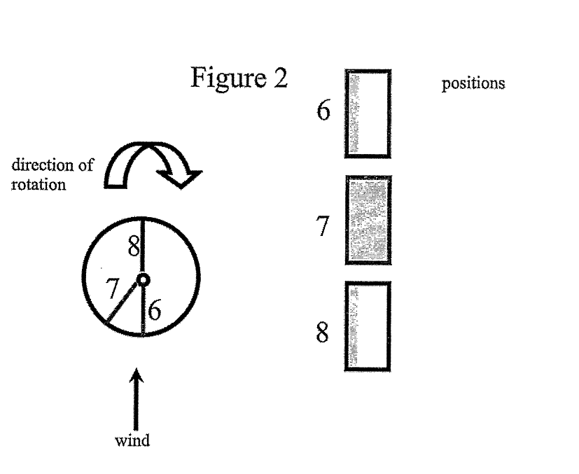

FIG. 2 shows the furling at different points in more detail. At position (6) the sail is furled. As it rotates from position (6) to (7), it is quickly unfurled and captures the wind energy. It thereby translates a spinning motion to the central rod. As it reaches position (8), it is furled again so it does not provide resistance on its return journey. (Furling==decreasing the sail area, unfurling=increasing the sail area.)

A system of more than one sail would ensure that each sail group would be maximally unfurled on one side of the semicircle whose chord is parallel to the wind direction, and maximally furled on the other side.

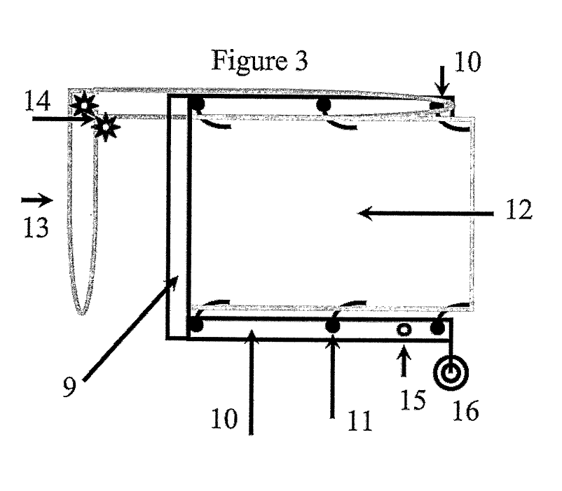

FIG. 3 shows one solution to the sail system of FIG. 1 in more detail in one embodiment. Part (9) is the vertical rod. Parts (10) are the horizontal extensions from it. (In other embodiments, the shape they make need not be rectangular.) Parts (11) are hooks inside parts (10) to which the sail (12) is attached. This illustration is figurative, as there can be many types of hooking mechanisms and ways of attaching a sail that moves in and out horizontally from a vertical axis. For example, in another embodiment, the sail can roll up and unroll down and be included in the definition of a drawing means. Part (13) is the drawing means. It can be rope, cable, or other material and can pass through any of many types of round structures. In the ideal embodiment, it is a steel cable coated with smooth plastic. Part (14) figuratively indicates a pulley or other means of using the drawing means to furl and unfurl the sails. A machine would be attached to parts (13) and (14) to accomplish the furling and unfurling actions.

The side extensions may need outlets (15) at the bottom for the draining of water from the rain if they are not solid. The hooks of the upper extension piece in certain configurations may provide that in the location where they slide. Part (16) indicates an optional peripheral wheel or group of wheels or other sliding means such as bearings, with or without magnets, running on a track or other surface, that support the periphery of the sail as it rotates.

An optional enhancement to the side extensions, in another embodiment, would be an automatic regreaser means.

In other embodiments, each “sail” could consist of multiple attached sails of smaller size.

In summary, the system of vertically rotating sails with an automatic furling and unfurling method is unique. The combination of the above with a generator, in the ideal embodiment located inferior to the central rod, is unique.

The various inventions described here can be made to work together in different embodiments and situations.

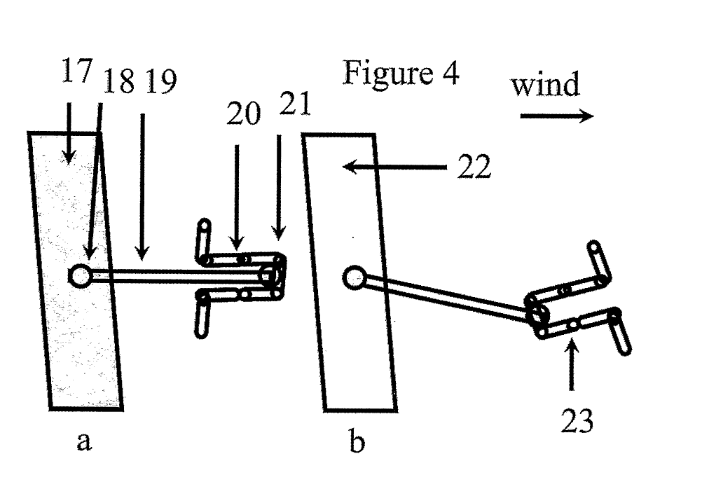

FIG. 4 is a solution of how a sail can drive a generator with minimal external movement. The key concept is to permit the sail to return furled—that is, with its sail not catching the wind—in its return path. The materials used can be canvas, nylon, metal foils, or any other material. The key point is that there be a means for the sail to capture the energy in one direction and produce minimal friction in the return direction. FIG. 4, section (a) shows the sail unfurled while it is driving a crankshaft in the same direction as the wind flow and thereby causing the crankshaft to rotate. The combination of a sail and a crankshaft, and a sail, crankshaft, and generator is an innovation of the current invention. An additional innovation is the means and method for causing the sail to furl and unfurl in coordination with the position of the crankshaft, so that the sail is unfurled for the forward movement of the crankshaft and furled for the return movement of the crankshaft. (“Forward” refers to the movement in the direction that the wind is blowing.) Part (17) is the unfurled sail. Part (18) is a sliding means on the sail holder; it would commonly be a ball bearing that enables pivoting of the sail as it moves forward to push the crank. Such a device is well known. It absorbs the horizontal motion of the sail and transmits it to the crankshaft. Part (19) is the shaft. Part (20) is the crank, which is connected to a generator. Part (21) is the pivoting means causing the movement of the crank by connecting the shaft to the crank, as is well known. The sail is mounted on any sliding structure that enables forward movement from the force of the wind.

Section (b) shows the sail (22) furled as the crank (23) and crankshaft return to starting position.

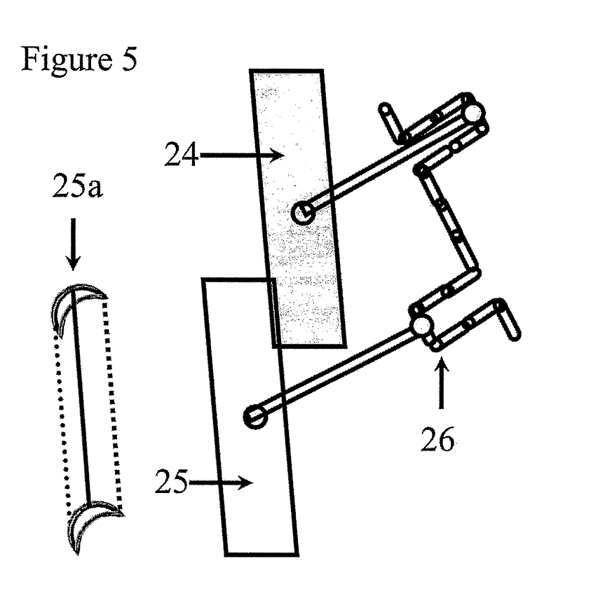

FIG. 5 shows how the system would work with a plurality of sails. This has the advantage of smoother motion. The sails operate in coordinated motion, with the sails in forward mode unfurled (24) and the sails in return mode (26) furled (25), as each sail is operative at a different part of the cycle. Multiple sails have the advantage of imparting smoother motion to the crank. An option exists either instead of or combined with furling the sail on the return trip. A panel (25a), in the ideal configuration an aerodynamically designed flow deflection object, automatically moves and blocks the wind from the returning sail. This can be used with single or multiple sails.

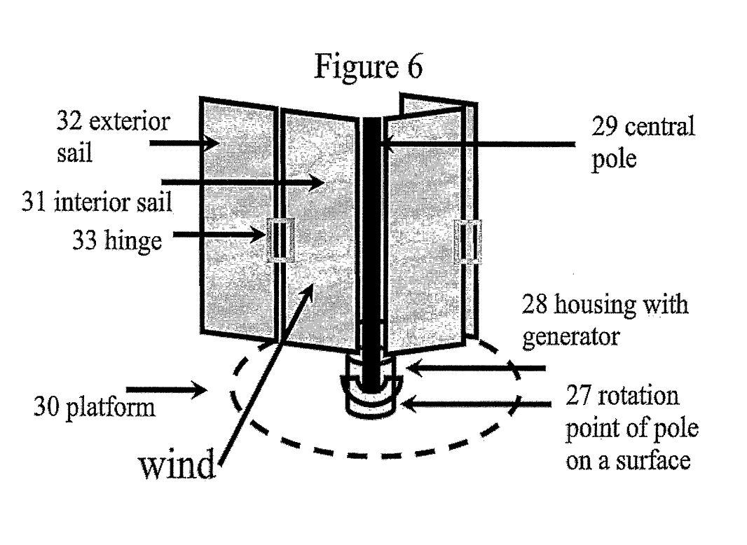

FIG. 6 illustrates part of the concept of a vertical axis sail system that self-adjusts, at least partially, the furling and unfurling to wind direction. A vertical rod (29) provides a central attachment point for at least one sail. The vertical rod is optionally attached at its bottom to a part (27) that allows rotation and forms part of a generator and its housing (28) that is attached directly or indirectly to the ground. The generator can be any of the group of generators well known in the art to create electricity from the spinning of the central rod. The sail structure consists of at least two parts, an interior sail (31) (although it need not necessarily be a sail; another kind of structure would suffice) and an exterior sail (32). The interior sail is connected, ideally fixedly, to the vertical pole in the center. A connecting hinge (33) restricts the motion in such a way that the external sail extends as a result of the wind in one direction, so that its radius increases when capturing wind, and folds in (flexes) on its return journey. In this way, more force is delivered to one side of the turbine than the other with minimal if any need for mechanical or electronic controls. Thus the structure spins from the wind. The use of a vertical axis sail with the hinge as shown connecting to a second sail is the basic innovative point. A platform (30) optionally surrounds the area of the housing.

The interior sail may optionally have an optional peripheral wheel or group of wheels or other sliding means, running on a track supported by the platform, that support the periphery of the interior sail as it rotates. In another embodiment, the exterior sail may also have such sliding means.

An optional enhancement to the hinges would be an automatic regreaser means.

In other embodiments, each “sail” could consist of multiple attached sails of smaller size. In other embodiments, additional exterior sails could be added.

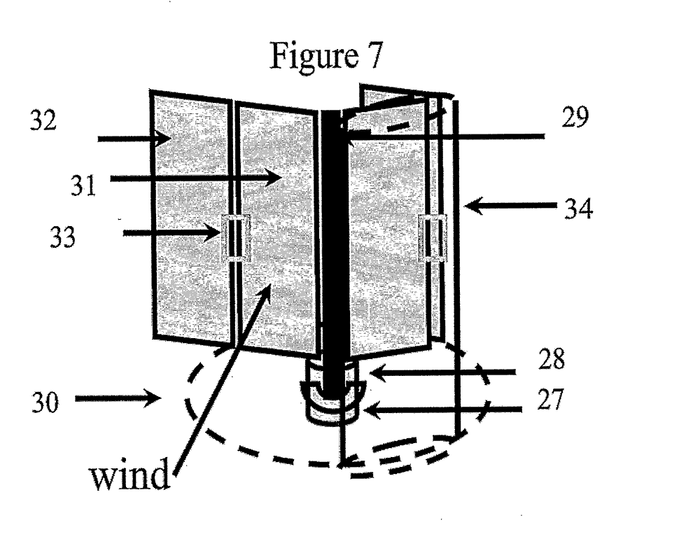

FIG. 7 shows the same structure with a vertical flow deflection device (34) placed at the perimeter of the rotation of the sails. It functions to accelerate the fluid or wind flow into the sails that are capturing the wind and to block the airflow into the sails making their return journey. In one embodiment, a single airfoil or other flow deflection device is placed with the leading edge facing the direction from which the majority of the wind in a particular location flows. In another embodiment, the position of the airfoil is coordinated with the wind with electronic controls. In the ideal embodiment, the imaginary line from the leading edge of the airfoil to the central vertical pole is approximately parallel to the direction of the wind in such a way that it maximizes the velocity flow into the sail.

In another embodiment, the base of the airfoils can move in a defined track on the platform or other adjacent structure for greater precision.

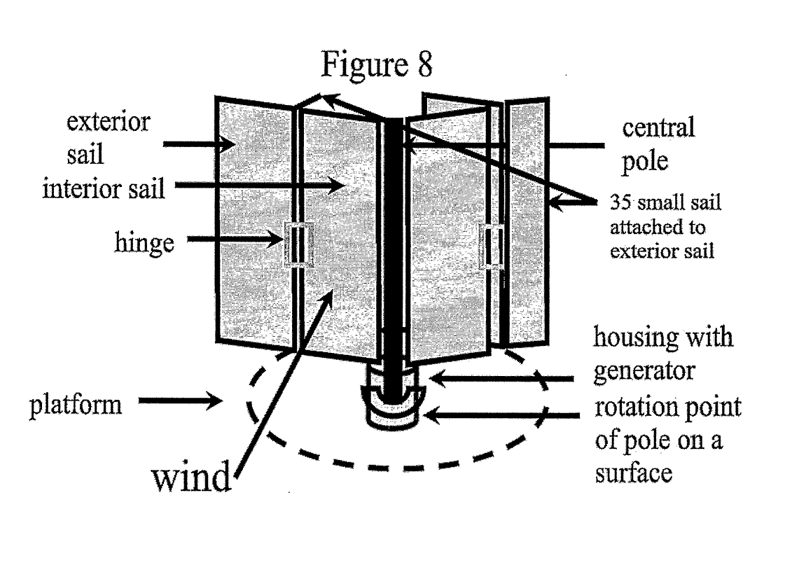

FIG. 8 shows another embodiment of the invention. A smaller sail (35) is attached to the exterior sail on its interior portion at an angle of at least 90 degrees in its ideal embodiment. (That means that it is ideally obtuse at the point between the exterior sail and the hinge in an orientation on the opposite side of the wind from the front of the exterior sail when it is fully extended.) It is on the side opposite the oncoming wind when the exterior sail is extended and on the reverse side on the return journey. It serves to capture the oncoming wind and extend the exterior sail sooner. On the return journey, the wind on it pushes the exterior sail into flexion sooner.

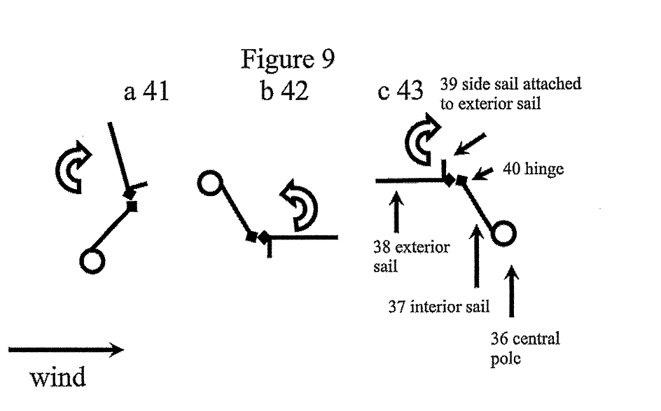

FIG. 9 illustrates superior views of the structures. The sequence a (41), b (42), c (43) illustrates significant points in the rotation of the sail. In (a), the exterior sail is capturing nearly the full power of the oncoming wind. In (b), the sail structure is making its return journey, and the exterior sail and its attached sail are being pushed into flexion by the oncoming wind. In (c), the oncoming wind has started to affect the side sail so that it helps to swing the exterior sail into position to capture the oncoming wind. (36) is the central pole, (37) is the interior sail (or panel), (38) is the exterior sail attached to (37) by a hinge (40), and (39) is the small supplementary sail to help the exterior sail swing around for the wind.

In summary, the system of vertically rotating sails, rather than blades and other solid shapes, is unique. In addition, the combination of vertically rotating sails with adjacent vertical foils is unique. The combination of the above with a generator, in the ideal embodiment located inferior to the central rod, is unique.

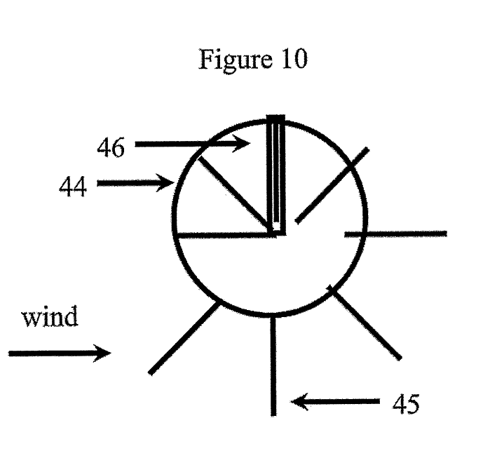

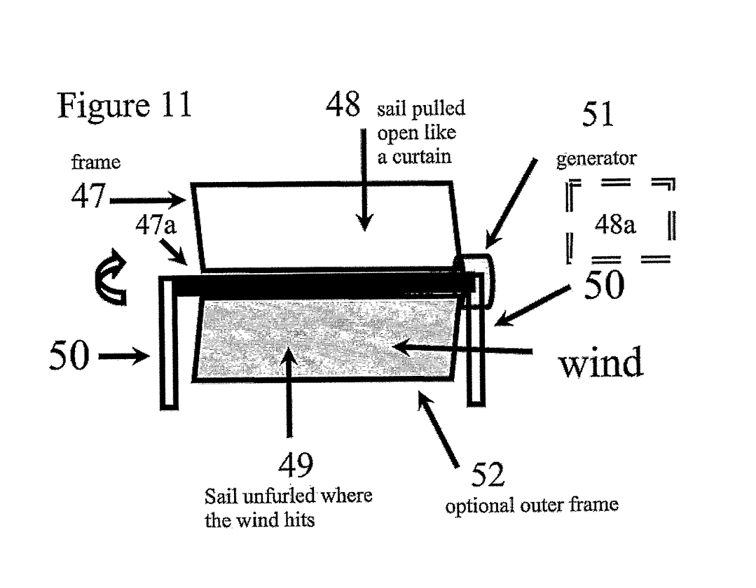

FIG. 10 shows how a central cylinder or drum can operate smaller paddles with sails. The paddles are completely extended when pulled down (45) by gravity and, on the return trip (44), slide into the drum along a guiding slider (46). Because this requires a proportionately thick central drum, the configuration in FIG. 11 is likely to be more successful.

FIG. 11 shows the operation of a horizontal axis sail. Two or more vertical stands (50) hold a horizontal bar (47a), spun by the attached at least one sail (48, 49), said bar driving a generator (51). The sails have means (49) for catching the wind in one direction by being unfurled and for reducing friction in the return direction against the wind by being furled (48). In one embodiment, the means is a simple curtain and slider that operates by gravity: When the sail is in the up position (48), the sliders bring the sail towards the center by the force of gravity as they slide down supporting bars (47). As the sail rotates, they automatically slide down (59) into position to catch the wind. The same effect can be created by adding a blocking panel for the upper half of the sail, if part (48a) were to be placed in front of (48).

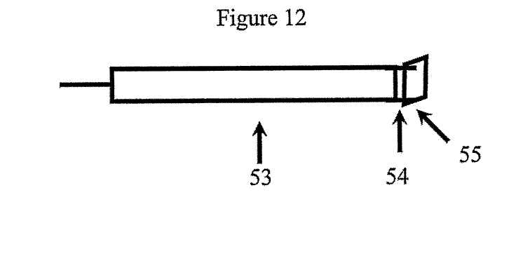

Several blade and sail parts can play a role in the energy capture as well in different machines. FIG. 12 is a diagram of a blade with a peripheral extension. (53) is the shaft of the blade, whether solid or a sail configuration. At its periphery is an extension (55), attached by at least one arm (54), at substantially 90 degrees to the length of the blade with an air space in between. The concept is to provide local higher velocity to the blade. The extension in its ideal configuration is an airfoil-like structure. The extension can be made of flexible material.

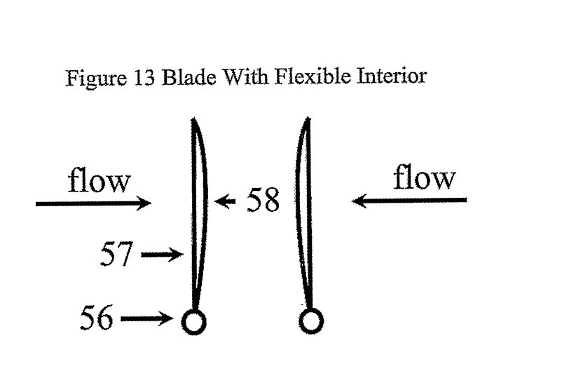

FIG. 13 is a diagram of a blade or paddle with a flexible interior. (56) is the hub of the blade, (57) is the frame, and (58) is the interior. The configuration shown here is unique in that the interior is not cut out to be tense. Rather, by not being flat and tense, it can assume an aerodynamic shape as the wind blows into it, and it can simultaneously be lighter than solid blades and, depending on the design, assume the same aerodynamic shape in either direction of wind flow, and be utilized for a two-way generation system for blades. In other configurations, this can apply to water flows. We define “interior” as consisting of a minimum of two sides bounded by a rigid frame with the flexible material attached to a minimum of two sides and thereby constituting the interior.

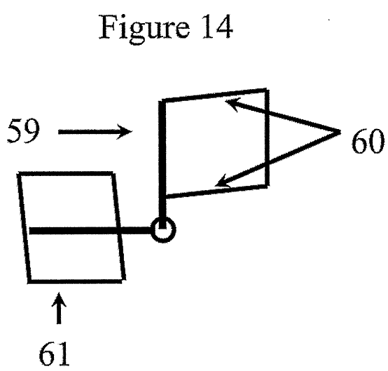

FIG. 14 is a diagram of sail extensions to a blade. The blade may be a thin rod (59) in one configuration with side rigid extensions (60 or 61) and a tense flexible structure attached to them. The tense structure may either begin at the edge of the blade (60), or the blade may be in the middle of the tense structure (61). One intention is that this arrangement can rotate while obtaining additional horizontal force.

Now we present a different way of looking at the use of sails. Other configurations here and elsewhere rely on the wind causing rotation of a device in order to produce power. Here we present configurations, in addition to the crank device shown before, that enable the capture of energy by using the linear motion of a sail into a device that captures energy in some form. The linear motion is arrested shortly thereafter by being transformed into energy. All these solutions may be optionally tied to a furling/unfurling mechanism as needed. The theoretical advantage of this is that sustained, or intermittent and gusting, mass flow of the air particles (or fluid particles in other configurations), could result in a higher percentage of energy obtained than in a rotating blade or sail. At the very least, it has the advantage of minimal external movement, decreased danger to living things, less noise and vibration, and perhaps a greater energy efficiency in an energy farm since the systems may be placed much closer together than in a blade wind farm. It may also result in decreased maintenance and downtime costs.

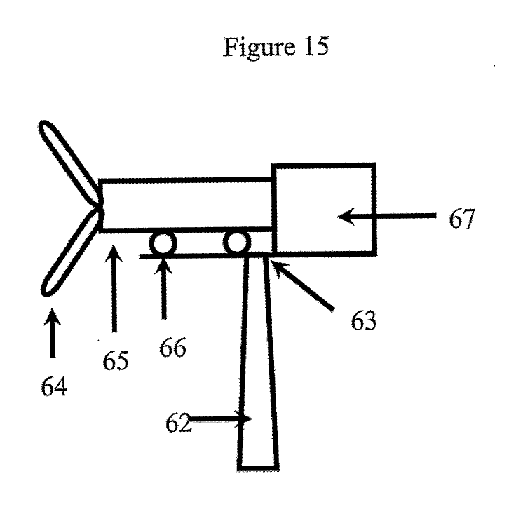

FIG. 15 is a diagram of the basic components of a linear motion sail turbine system facing a horizontal axis. Wind is coming from the left. (62) is a supporting structure, such as a wind tower. (63) is a connection to a platform holding the energy capture part of the system. In one embodiment, this platform is rigidly connecting to the energy capture part of the system. In some embodiments the platform is flexibly attached to the tower or support structure and has means for enabling the orientation of fluid capture to change by horizontal rotation, and in other dimensions as well. It further has means to lock and unlock the orientation, so that it can be pointed in one basic direction, say 0 degrees with a locking restriction at −270 and 90 degrees, and allowed to rotate with the direction of the wind from −270 to 90 degrees, as an example of one embodiment. The exact choice of this part of the design can be customized to wind conditions, such as whether the wind blows consistently in a certain direction at a certain location. Part (64) is a wind capture component, such as a propeller blade, sail, or a series of propellers that are sails. Ideally, it is a big sail facing the direction of the wind. Part (65) is the structure that holds the wind capture component. It may, in one embodiment, include a generator for rotation based on blade rotation from the wind capture component. In another embodiment (the one most central to the current invention), it may also have the ability to move in a horizontal direction from the horizontal force of the wind. In another embodiment, it has only horizontal force based on wind energy capture from a sail. This device of parts (64) and (65) is moveable, mounted on a set of means such as bearings, sliders, and wheels (66). Parts (64), (65), and (66) then transmit horizontal force to an energy-capture device or a pressure-absorbing device, represented generically as part (67), which in turn operates as a power and/or heat generating system. Part (67) can be any of a number of systems.

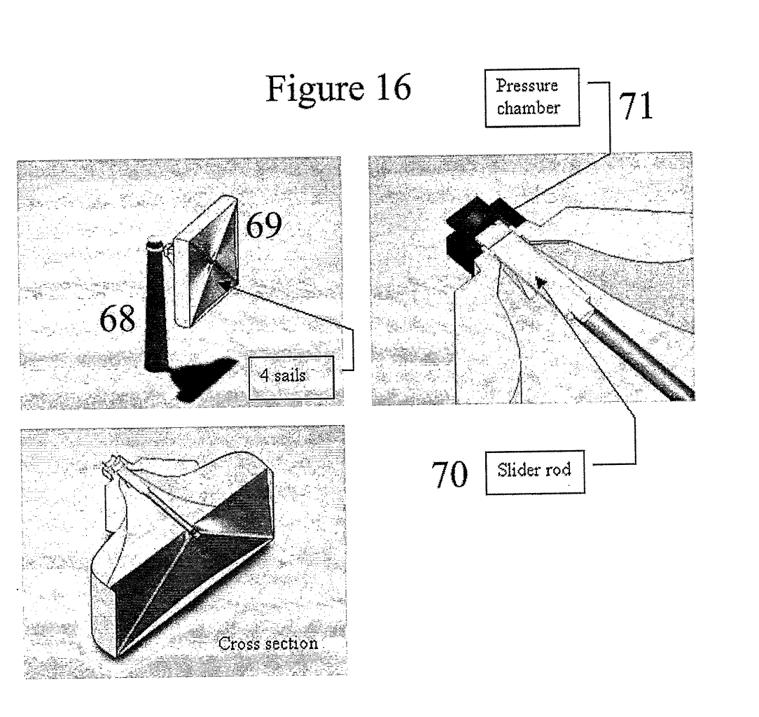

FIG. 16 is a 3D diagram of one configuration of part of a linear motion sail turbine. (68) is a supporting tower and (69) is one configuration of a sail to capture energy. In one configuration, a slider rod (70) is the means for taking the linear force of the sail and moving it into another object, in the configuration here shown, a pressure chamber (71).

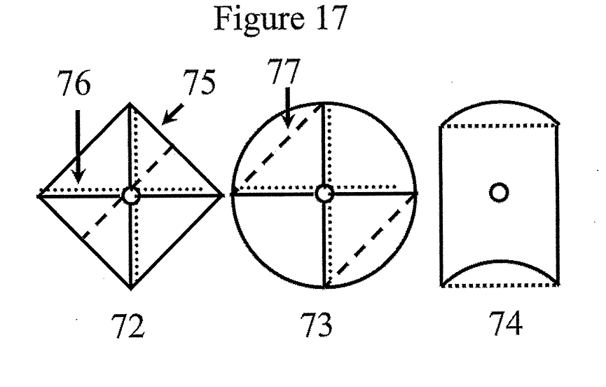

FIG. 17 shows some configurations for sails for a linear motion sail turbine. In one embodiment, the wind energy capture device may consist solely of a stationary sail or series of sails in an umbrella-like shape (72) attached to a linear motion capture device, ideally through a means such as slides, bearings, or wheels, whereby the horizontal force of the wind is transmitted into pressure or horizontal movement, and then into energy. In one set of embodiments (72, 73), the sail wind energy capture device actually comprises several smaller sails, ideally four arranged into a square or a circle, to form the wind capture component. The best embodiment is likely to be the square arrangement (but with its edges parallel and perpendicular to the ground, as if picture 72 were rotated on its side). Figure (74) shows another embodiment likely to be useful in wind farms. The rectangular/slightly semicircular arrangement directs the wind flow superiorly and inferiorly after hitting the sail, thereby enabling many sails to be located close to each other horizontally. The series of sails is ideally connected from one beam or side (75) to another on the opposite side, much like an opened umbrella with reinforcing cross-connections at the outer edges. These cross-connections or beams, in various embodiments of either substantially rigid or flexible material, and in different cross-configurations, and connected either to the masts or to the flexible material, are represented by the dotted or dashed lines in the figure (76, 77 and the dotted lines in sail 74). The cross-connections need not be in the exact configuration shown, as that is only one embodiment. The cross-connections would reinforce the shape of the sail mechanism as pointing slightly forward into the wind and prevent it from flipping. (The same design would be useful in umbrellas, which often flip in strong wind. A cross-connection that tightly connects the periphery of supporting structures of an umbrella when opened is an application of this principle.) The shape of the total configuration in such a bladeless wind energy device can be rectangular in one embodiment. The cross-connections in one embodiment consist of a single piece that traverses the entire diameter of a sail, but it would be better to have at least two cross-connections. In a circular sail or umbrella, there should be at least two that encompass at least 90 degrees of arc, or a series of smaller ones. Ideally the cross-connections are symmetrical and encompass a total of no less than 180 degrees of arc. In a polyhedral sail, such as a rectangle, two distinct cross-connections from one edge to an adjacent edge, each inclining the rectangle slightly toward the wind, should be adequate, but an encircling series of cross-connections would be better. The cross-connections could in another embodiment be made from a rope that encircles the sail system; pulling it tighter would enable the resistance to flipping in strong winds. It could encircle the sail system by a variety of means, including being threaded through tube connectors on the outer edge of a sail system. The cross-connections could be near the corners to prevent flipping at the corners.

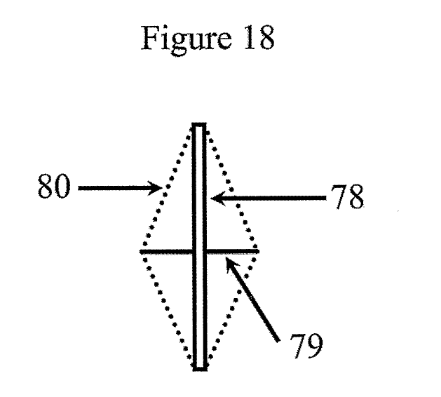

FIG. 18 shows a configuration for a sail for a linear motion sail turbine, and this would enable a two-way sail that operates in all wind directions except exactly 90 and 270 degrees. Part (78) is the sail or series of sail components. Part (79) indicates a horizontal extension to which flexible attachments (80) are made to at least two edges of the sail structure. A control system enables an operator or an automatic sensor to reverse the orientation of the sail on demand, so that its outer edges incline towards the oncoming wind, for example, by pivots at the intersection of parts (78) and (79).

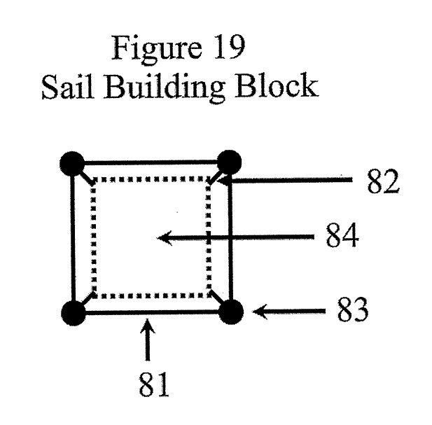

FIG. 19 shows a building block sail for sails for a linear motion sail turbine. In the ideal configuration, larger sails can be made of smaller polyhedral sails of at least three sides (81) that snap together. The corners of each have snapping or other connection means, and, optionally, means to attach flexible attachments such as part (83). Part (84) is the sail, attached to the snappable edges by part (82). In the ideal embodiment, each sail building block has dimensions less than the 8 foot width and 8.5 foot height of a standard container.

In all cases, the radial masts of a sail system need to connect to a central object in order to allow that central object to obtain all the force from the sail, and then to transmit it into linear motion. This horizontal motion may occur from sliding or from wheels.

The blade turbines use well-known electric induction means of a magnet spinning in a coil. The use of a sail system requires the development of a variety of generators that increase the induction of energy from the application of sometimes constant and sometimes varying force without necessarily using a spinning magnet attached to a set of blades and a coil as the first step. The basic classes of solution for this are the Piezosail, Thermosail, Pressuresail, and the Magnetosail. There may be several configurations of each. In all cases, the generators and the strength of their components are designed so that more energy (whether electricity, pressure, heat, etc.) will be generated as the wind (or fluid) speed increases and the force increases or as gusts occur. One similar principle used is the generation of increased magnetic repulsion from increased wind energy. These new generating systems represent a series of innovative techniques and devices and will be discussed later.

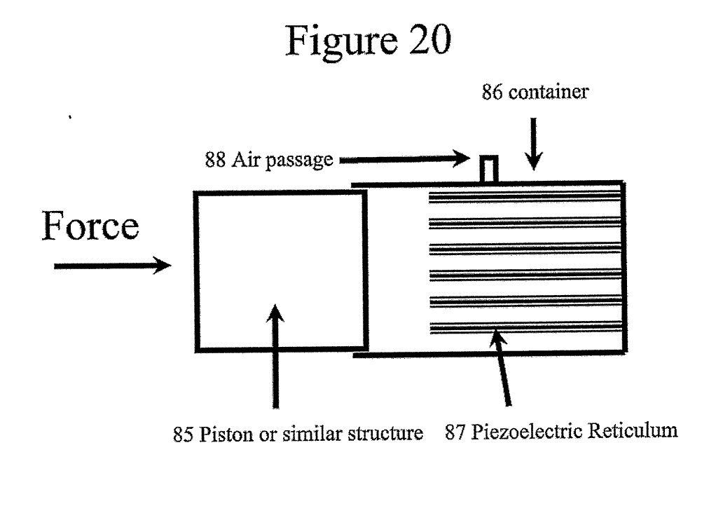

FIG. 20 is a conceptual outline of a piezoelectric or nanomaterial component for a linear motion sail turbine. This is the concept of a Piezosail. A piezoelectric reticulum generator is shown in FIG. 20. Linear force drives a piston or similar structure (85) into a chamber (86), that allows direct physical deformation of the piezoelectric layers (87). The layers shown here are conceptual; they do not need to be in the orientation or shape shown. [The chamber is optionally airtight and creates high pressure throughout the chamber. A reticulum of piezoelectric materials is located there. It can be at any orientation, but the air pressure or mechanical pressure needs to affect all the material.] The increased force causes an induction of current in the material in each part of the reticulum, which material is then connected to a wire that captures the current. (The reverse configuration, with the piezoelectric materials located on the piston, would also work, but not as well, because here the wires can remain in a fixed configuration.) An optional air pump or passage (88) enables the replacement of any air that escapes and/or enables the piston to spring back. An optional compressor can also enable the layers to spring back.

Let us try to roughly estimate its production of electricity. According to the company AMP, a 116 sq cm plate of 40 ply PVDF material (1.1 mm) deflected 5 cm by 68 kg 3 times every 5 seconds results in the generation of 1.5 W of power. A compressor operating on 11600 sq cm of piezo material would produce 150 W every 5 seconds or 1800 W per minute. A 20×20 meter sail produces 1197 kg/sec or 71820 kg per minute. Then 71820/68 times 150W=158426 W/minute, or 9505588 W/hour=9.5 MW per hour. (This figure does not take inefficiencies into account. Clearly they exist and the figure of 3 times every 5 seconds may not be accurate. The point is to show that energy could be captured through this means.) A thicker film might allow the production of more electricity.

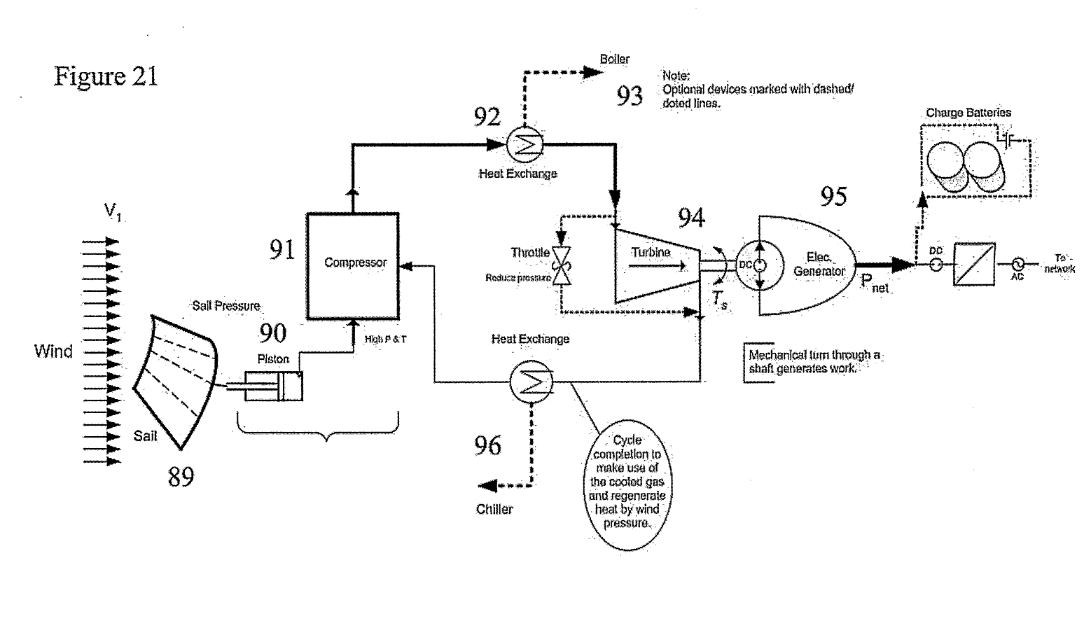

FIG. 21 is a Thermosail flow chart. In FIG. 21, wind force collected in a sail (89) drives a rod into a piston (90), connected to a compressor (91). This enables heat exchange (92). This heat can be shunted off to a boiler (93) as a means of providing heat. This is more efficient, if heat is desired locally, than producing electricity and then heat. The heat can also be used to operate a turbine (94) connected to an electric generator (95). Returning cooler air (96) to the compressor completes heat exchange.

In one embodiment, the device comprises a chamber filled with gas or other material. A piston or membrane connected on one side to the wind turbine or other energy capture device enables the transfer of pressure to the chamber. A one-way gas valve may be a useful component. The heat from this can then drive a steam turbine, provide heated gas or liquid, or be useful in other, known ways. The connection to a wind energy device is a unique part of the current invention.

Another device that can work in association with such a system of semi-continuous pressure is a closed chamber that contains at least one turbine and at least one one-way valve. The heated substance within the chamber rises, drives the turbine, cools, and returns to the location where it can be reheated by the pressure.

Another related device that would work primarily on pressure would be to concentrate the pressure in a chamber which will then drive the air through blades. This may be less efficient than external blades, but can reduce noise and danger.

There are many possible configurations of the pressure concept.

This connection enables other designs that take full advantage of the potential to create heat or other energy from the horizontal flow of wind energy. A system of blades, ideally made of sails, for a wind energy device that are in the ideal embodiment angled to a specification of at least 45 degrees and less than 90 degrees to the oncoming wind and of larger width than the propeller blades currently used would now be more cost-efficient, such as a turbine consisting of sails arranged at angles to oncoming wind in the shape of a propeller but larger in width than current propellers. In this manner, the standard wind turbine rotation and energy capture can be enhanced by the capture of horizontal energy.

The thermosail concept uses the heat generated by exerting pressure on a closed volume of gas. As the wind exerts pressure on the sail, we get high temperature gas (using the known equation of state PV=mRT for pure gas) to be later expanded through a turbine or expansion valve, thereby generating electrical energy as an output of mechanical shaft rotation.

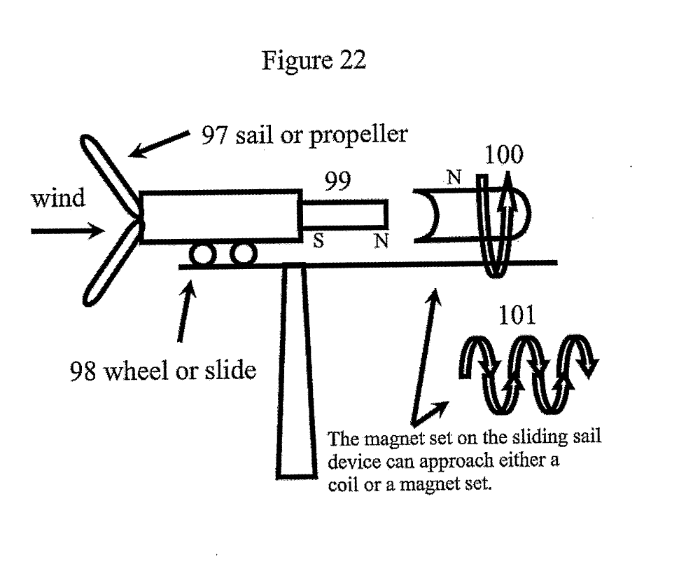

FIG. 22 is a Magnetosail outline. The sail (97) captures wind energy and turns it into linear motion on a body mounted on a sliding apparatus such as wheels (98), which drives a first magnet set (99) into another structure, either containing another magnet set (100) that first magnet set (99) causes to move and thereby creates electricity by rotation, or containing a coil set (101) that directly creates a current. (Magnet set is a term used throughout this patent to designate at least one magnet, oriented in a direction to produce the effect desired. In general, if the magnet set comprises more than one magnet, their poles will be oriented in the same direction.) The labels N and S for north and south indicate that repulsion can be used to create movement in magnet set (100). This figure does not describe the exact configuration of the magnet sets. Later pictures will give more detail. The illustration shows that the first magnet is driven towards a device that enables induction of flux and/or current. This can be an armature, wire, or another magnet set. In most cases, this mechanized force generates work and drives a generator.

This system in its ideal embodiment operates on the principle of driving a magnet into a magnetic field and causing generation of electricity from the process. This application of wind energy is novel to the current invention, as is the arrangement of the magnets.

The current invention of a Magnetosail shows that a north magnet driven towards a north magnet can create sustained electricity in the presence of minimal back and forth movement. One of the advantages of the current invention is the easier construction and maintenance of a system based on fairly continuous pressure from the energy capturing part of the invention. Couplings and devices to lock the rotation into steps can be applied in other configurations.

The systems shown here are ideally constructed with permanent magnets that have high coercivity (ability to withstand removal of the magnet's charge). In all cases, a temperature control means will be added if necessary to preserve the permanent magnet's coercivity at a high level.

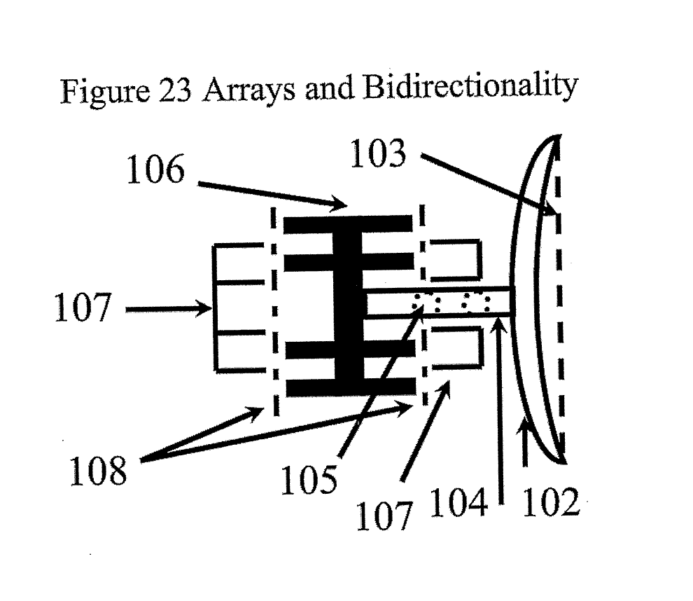

FIG. 23 is a diagram of arrays and bidirectionality. It represents the configuration of a two-way sail and is useful for a number of the energy conversion techniques discussed in relationship to sails. A sail facing either 0 degrees or 180 degrees will absorb energy from winds of almost all directions, even without a system for rotating the sail system on the wind tower. A two way wind system means that wind towers can be placed very close to each other in cases where the wind comes from more than one direction. Part (102) is the sail. Part (103) in dashed lines represents the device that inclines the sail towards the oncoming wind or provides a structural support for the sail. Part (104) is the shaft or other device that holds the sail, and has wheels, bearings, or sliders (105) on at least one side to enable horizontal movement. Part (104) is connected to a series of energy capture devices (106) such as magnets arranged in teeth or a series of pistons and compression chambers (107). The minimum is one energy capture device on each side. The advantage of an array in parallel is that larger forces can be turned into useable energy. In a Magnetosail, as parts (106) move closer to parts (107) on either side, magnetic flux increases and more current is produced by the attached generators. In a compression chamber series, more compression occurs on that side. Part (108) indicates where magnetic shielding may be placed either during assembly or after assembly in conjunction with a control mechanism that can remove and insert them in the configuration of a Magnetosail.

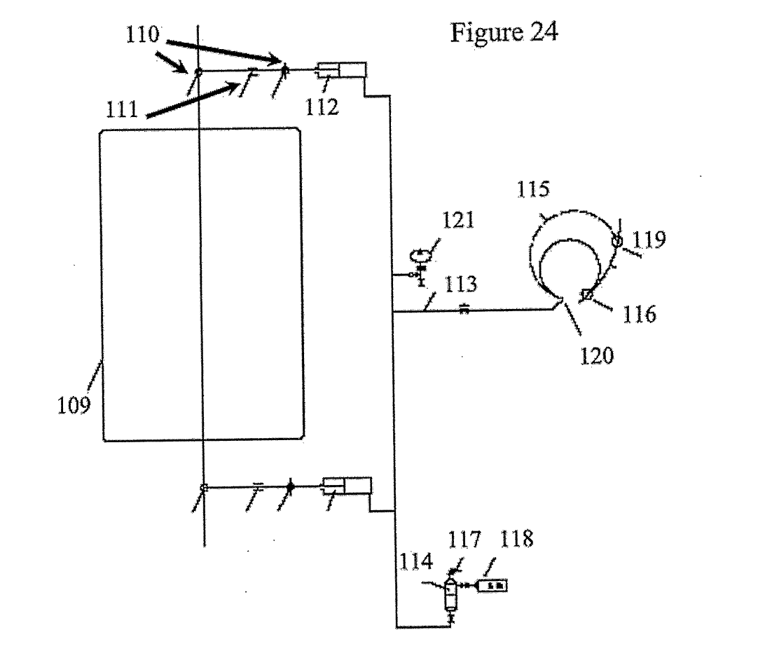

FIG. 24 is a diagram of the use of compressed air for electricity generation. It translates wind energy into hydraulic pressure into mechanical movement. This has the advantage of changing unpredictable energy flows into exchangeable hydraulic pressure. The wind blowing on a sail (109) causes pressure on pivot points (110) and a rod in sliding bearings (111) into a piston or hydraulic cylinder (112). Here the sail is shown with two sliding points of attachment, pistons, etc., but one is adequate. The piston is connected to a pressure pipeline (113) to an hydraulic accumulator (114) and to a Bourdon Tube (115). (This use of a Bourdon Tube is a unique concept in wind energy.) Increased wind increases pressure throughout the system and results in straightening of the end (116) of the Bourdon Tube and mechanical energy. (116) is the endpoint at closed position and (119) is the endpoint at open position. (120) is the fix point. (121) is a pressure indicator. Excess air pressure is separated at relief valve (117). Compressed air pressure is shown by (118). Pressure fall as a result of negative wind (suction effects) shall be compensated by air entrance through (118). Overpressure resulting from storm conditions will cause the relief valve (117) to open and reduce pressure to a maximum allowable pressure. Movement at the free end extends along the elliptical length of (119). This arrangement can translate gusting into pressure and energy.

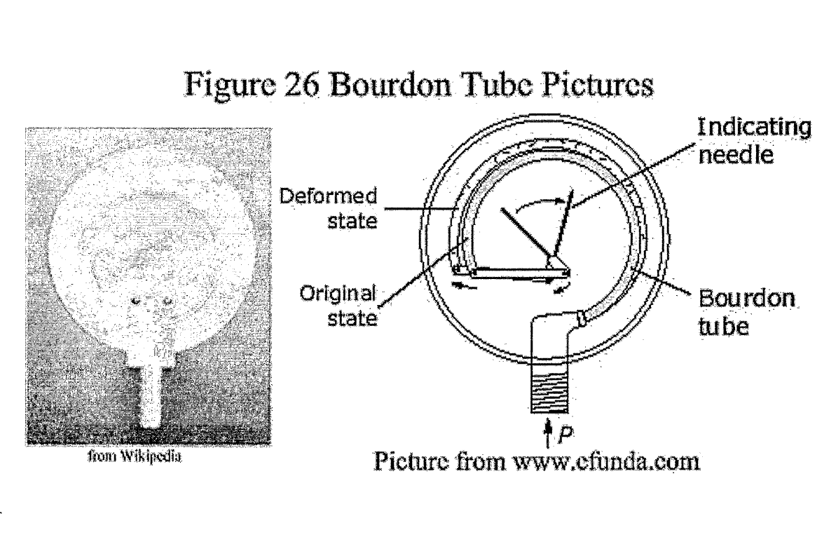

FIG. 26 shows two diagrams of a Bourdon Tube.

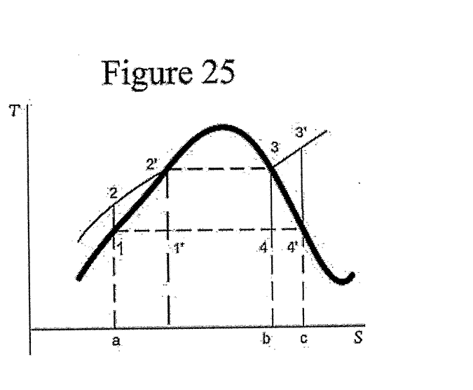

FIG. 25 is a chart of power from a thermal system. The Thermosail thermodynamic cycle is described on a T-s diagram. This is a common way in thermodynamics to analyze the work and heat flow. As an example, using a Rankine cycle and assuming simple steam power and an ideal cycle, the processes are:

1-2 Reversible adiabatic compressor (pump)

2-3 Constant-pressure transfer of heat in the boiler

3-4 Reversible adiabatic expansion in the turbine (or other engine)

4-1 Constant-pressure transfer of heat in the condenser

The net work done by such a cycle is the area in the graph 1-2-2′-3-4-1.

The thermal efficiency of such a cycle is defined by the relation

$${η}_{th} = \frac{{w}_{net}}{{q}_{H}} = \frac{A ( 1 - 2 - {2}^{′} - 3 - 4 - 1 )}{A ( a - 2 - {2}^{′} - 3 - b - a )}$$

We have to calculate the work that can be done by this kind of cycle.

For instance w₂=h₂−h₁ [first law of thermodynamics]

and using the fact that s₂=s₁ [second law]

one can find the total work done by the cycle and the efficiency can be calculated.

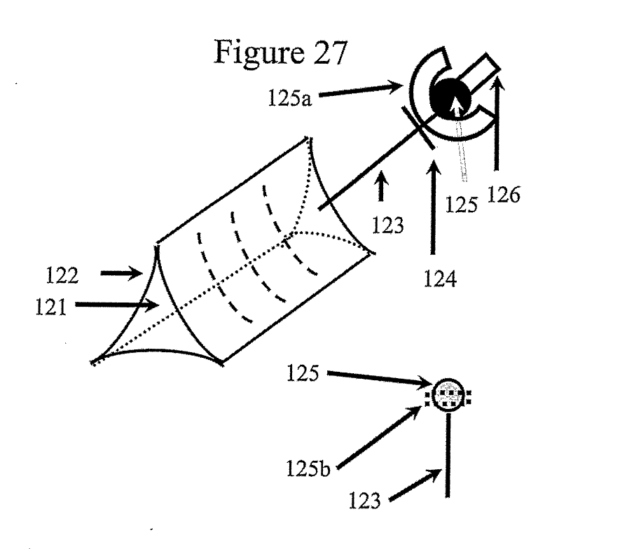

FIG. 27 is a diagram of a paneled device hanging like a pendulum. Parts (122) show how a group of at least 3 panels, ideally shaped slightly concave to the direction of flow, with a cross-section as shown in (121), can adjust to a fluid flow from any direction. In one embodiment, the panels are sails. The device swings from a pendulum (125) that has an attached means of generation (126) to produce mechanical or electrical energy by movement of the pendulum. Said means can be varied, such as magnetic, compressed air, etc. Said means in one embodiment offer the possibility of energy generation from at least two directions of flow, and, in another embodiment, offer the possibility of part (126) following any of several defined paths with energy capture along that path. The picture of part (126) is a generic picture, since any of a number of means can be attached at this point. The pendulum can swing in any direction, not like a typical clock pendulum. The pendulum ball (125) is attached by a rod to the panel set. The pendulum ball rests in a socket (125a or 125b). On the other side of the cup, attached to part (123), is a piece (124) that prevents the pendulum ball from disengaging from the cup. There are three ways to prevent vertical disengagement: Part (124) prevents the shaft from sliding up. It can allow partial sliding by being located some distance from the socket, so that there can be an impact from vertical movement. Part (125a) partially surrounds the upper part of the ball as well as the bottom. Part (125b) surrounds the central area of the ball on each side, and allows maximal movement.

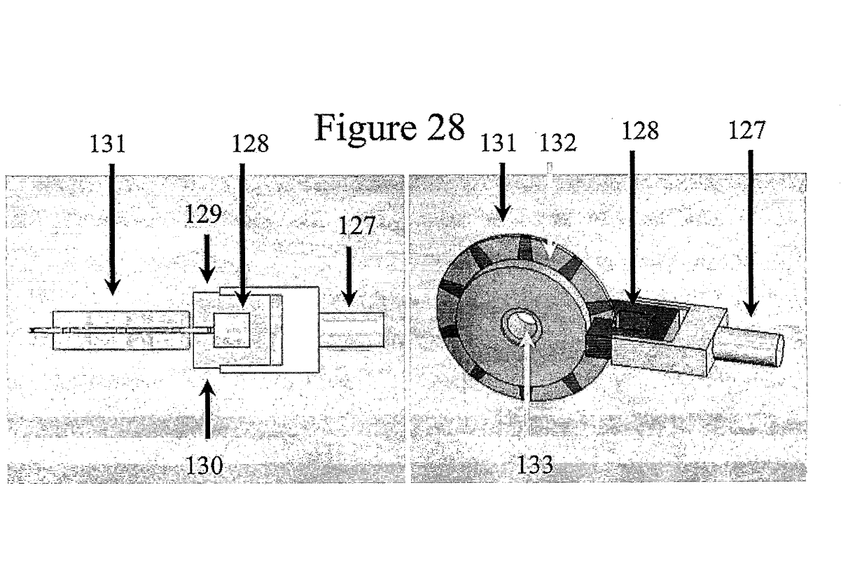

FIG. 28 presents two 3-D views of what we can call a Magnetic Clamp Generator or a Magnetic Sandwich Generator. An innovation of the current invention is the use of two opposing magnetic sets to turn linear motion into easily electrified rotational motion. The magnet sets are arranged so that greater force leads to greater apposition of the magnets, greater resistance, greater flux, and greater electricity output. At the very least, the magnet sets can be accompanied by directional means to force movement in one direction with each gust. In the ideal embodiment, the linear motion can result in smooth rotational motion. The basic ingredients of the invention are the use of North-North and/or South-South opposing magnets in the correct orientation. Then the use of magnetic shielding provides control of directionality. Part (127) imparts linear motion to the first magnet set (128). It can be an extension of the sail/panel system shown earlier, or can be part of any other system providing linear motion, such as gravity in a vertical direction, or fixed pressure from the walls of a housing. Although, in one embodiment, the first magnet set could work by providing magnets on just one side of a rotor (131), in the ideal embodiment, the first magnet set provides magnets on both sides (129, 130) of a rotor. In the ideal embodiment, one side presents North and one side presents South to the rotor. The rotor has its own magnet sets (132); in the ideal embodiment, they alternate areas of North and South, or North with magnetic shielding, or South with magnetic shielding. The rotor has a center (133) that can hold a shaft that runs inside a separate electrical generator. The clamp can assume many shapes other than the one shown here.

In all cases of a clamp, the polarities of both sides of the clamp can be N-N, N-S, or S-S, as long as the central rotor's facing polarity causes repulsion.

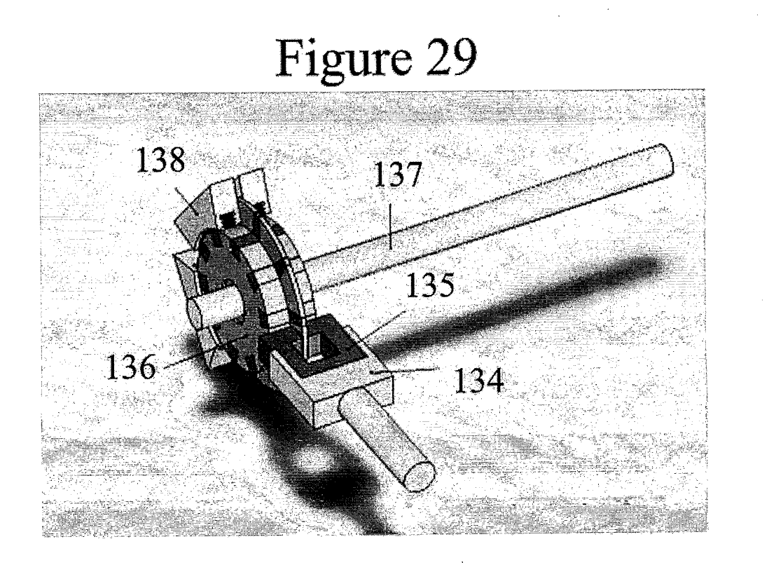

FIG. 29 is a 3-D view of a magnetoclamp with a rotor and a coil. As the clamp approaches the rotor, the repulsion increases and the speed of the rotor increases. This speed can in one embodiment drive a shaft connected to the rotor, that in turn drives a generator. In another embodiment, coils adjacent to the side of the rotor opposite the clamp enable the direct induction of electric current. Both may be used together. Part (134) represents the means of linear force, such as the bar attached to a sail. Part (135) is the first magnet set. Part (136) is the rotor with the second magnet set. As it turns, it turns a shaft (137) to generate electricity and/or has a part that spins through a coil (138) to produce electricity. In general, the use of (138) is not the ideal solution because of the heat it would create in the area of the second magnet set, but it can find an application in certain circumstances. In one embodiment, the magnets of the two sides of the clamp face each other exactly; in another embodiment, they are separated slightly in degrees of arc from each other.

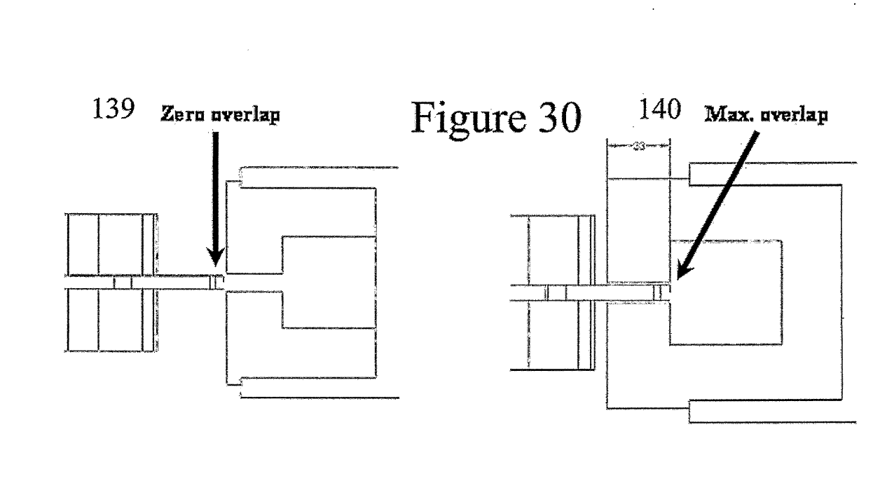

FIG. 30 shows overlap in the magnetoclamp concept. This is to make clear that position (139) produces little energy and position (140) produces more.

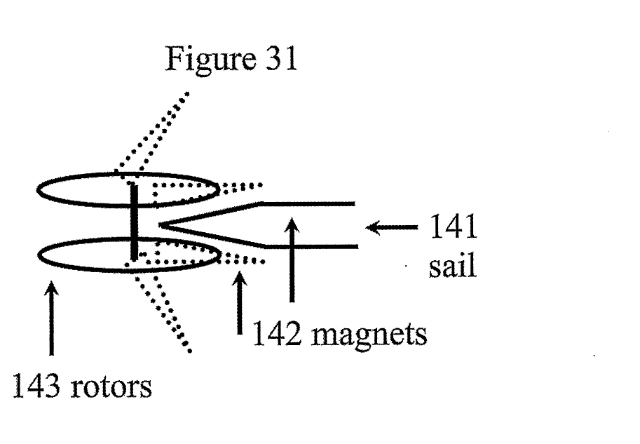

FIG. 31 is a view of one kind of magnetoclamp sandwich. In this case, instead of a clamp surrounding a rotor, two rotors (143) can surround the first magnet set attached to the origin of linear force (141). Both the origin of linear force and the rotor have their own, opposing magnet sets (142).

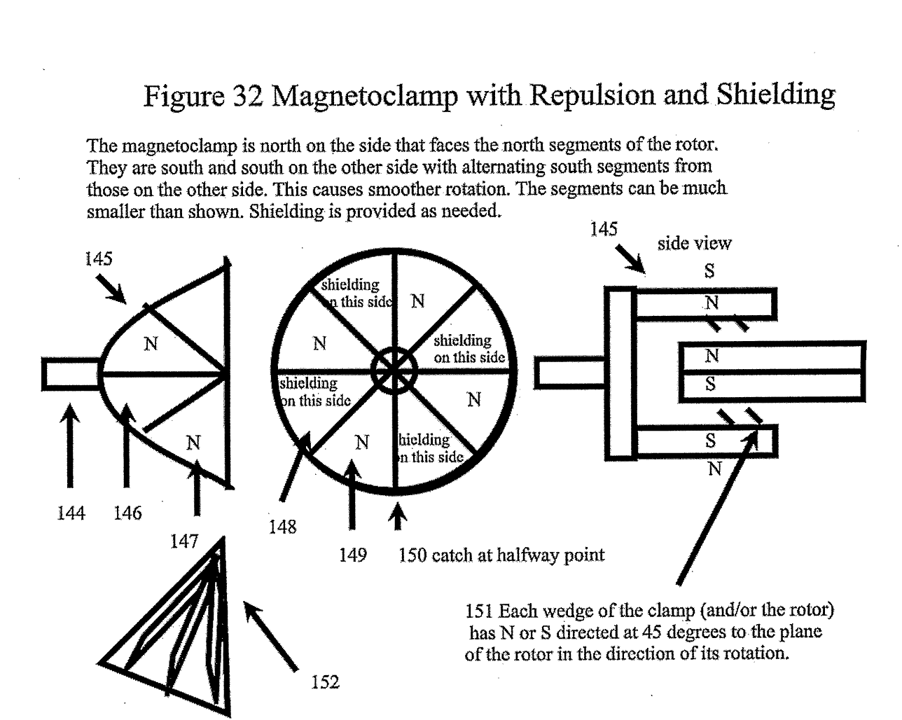

FIG. 32 is a diagram of the details of a magnetoclamp with repulsion, angling, and shielding. This addresses the problem of potential locking by the system in between areas of magnetic repulsion. Part (144) shows the origin of the linear force. Part (145) is the first magnet set, ideally consisting of a semicircle so that it does not cause interfering patterns with the distal part of the rotor. Therefore a catch (150) at approximately halfway or less prevents this problem. Part (145), the first magnet set or clamp, ideally surrounds the rotor on two sides and present magnetic force North on one side of the interior and South on the other. The rotor's magnet sets have North facing the North of the rotor and South facing the South of the rotor. Any combination of repulsive forces can be used. Ideally, both the clamp and the rotor have pie-shaped alternating areas of magnets and shielding in order to prevent locking of the clamp and rotor (146, 147, 148, 149). In the ideal configuration, the rotor and the clamp on both sides have the magnet strips at a 45-degree angle facing each other. (151) Any angling at all in the correct direction, with all magnets on any one magnet set oriented in the same manner, provides an opportunity for the rotational force to be applied in the desired vector. All magnet strips are oriented to cause force from repulsion in the same rotational direction. (152) In other embodiments, the angle need not be limited to 45 degrees, and only one of the two major magnet sets needs to have an angle. The crucial point is to create repulsive force in one circumferential direction only by using angled repulsion and shielding.

In another embodiment, the first magnet set (the clamp) can also come into greater proximity from the side as the linear force increases.

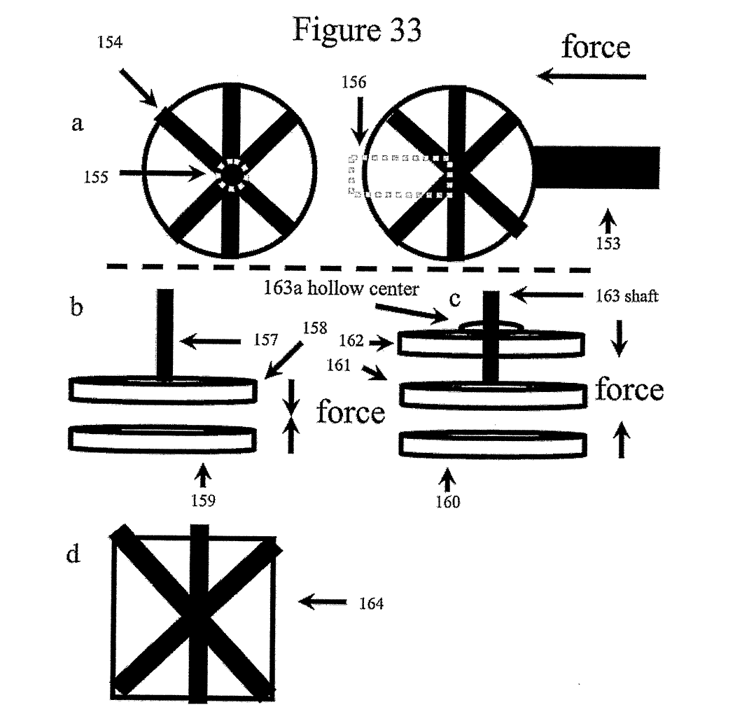

FIG. 33 is a diagram of other ways of constructing a Magnetic Generator. In section (a), (153) represents the linear force of the first magnet set in the direction of the rotor's second magnet set. Both magnet sets have strips (154) of repulsively arranged North-North or South-South magnets that come into proximity. (In the ideal configuration, the strips shown here are at an angle. All angles need to be in one direction along the circumferential path; the “strip” really needs to have a different direction on each side of the hub.) The rotor spins a central shaft (155). In order to approach as completely as possible, the first magnet set has a central hollow area (156) greater than the diameter of the shaft at that point. Sections (b-d) show how increasing proximity from the flat side can cause generation of power. Two discs (158, 159) with radial and opposing magnetic strips come into proximity in the plane perpendicular to the discs and turn a shaft (157) that generates electricity. The discs need not be circular; at least one can be of another shape such as (164). In fact, even one strip approximating a disc attached to a shaft would be adequate to cause the disc to spin, but that is not ideal because the movement would not be maximal and would be irregular. Section (c) shows that two discs (160, 162) can sandwich a third (161) with magnets on both sides using the principles discussed. In this case, disc (161) holds the shaft (163) that passes through hollow space (163a) on external disc (162).

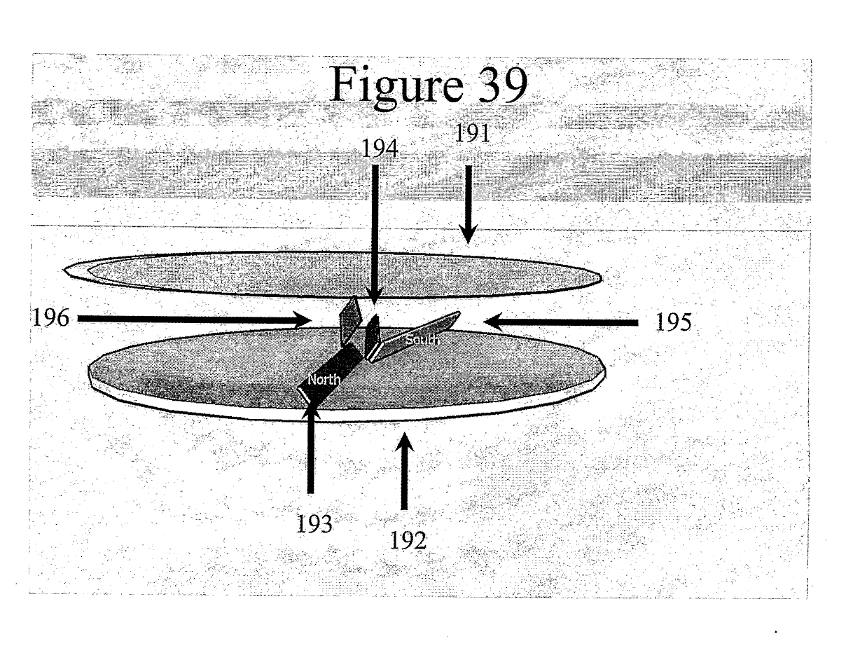

FIG. 39 is a diagram of the orientation of the magnet sets. This will help clarify the oversimplified FIG. 33, which, from that perspective, just shows strips of magnets. (191) is a structure or rotor with a first magnet set—meaning the magnets that are a part of or attached to it. (192) is a structure or rotor with a second magnet set. (196) is meant to be attached to (191) whereas (193), (194), and (195) are attached to (192). (193), (194), and (195) are arranged around a central hub. In all cases, the north side of the magnet is pointed in the same direction at around 45 degrees. It is not easy to see from the picture, but (196) is meant to be at the far side of the upper rotor so that its North side faces the North side on the far magnet (194) on the lower rotor. In other embodiments, other angles may be used. Magnetic shielding is the ideal embodiment for all of the magnets except on the surface facing the other magnet set. The shielding is not shown in this picture. The lighter surfaces on parts (195) and (196) represent South, and the darker surfaces on (193) and (194) represent North. The polarity of the surfaces may be reversed as long as the pattern is followed. The picture does not show all the magnets that may be used; the picture is meant to show a point. It is important that enough magnets be used to move the rotor from one area of repulsive force to the next area. The magnet attached to the upper rotor in the picture is directed towards the same polarity on the lower rotor—and the same with all the magnet sets. One rotor may have the magnet sets flat in one embodiment. The rotors may have pie-shaped magnets in another embodiment. Magnets at opposite sides, such as (193) and (194), do not have to be positioned so that their lower edges touch; that is just one embodiment. It is ideal but not necessary that the magnets on each rotor be symmetrically arranged. The distances between the chords of the magnets on each rotor can be either the same or different in various embodiments. The object is that apposition of these two magnet sets produces rotational motion in at least one of them in as smooth a manner as possible.

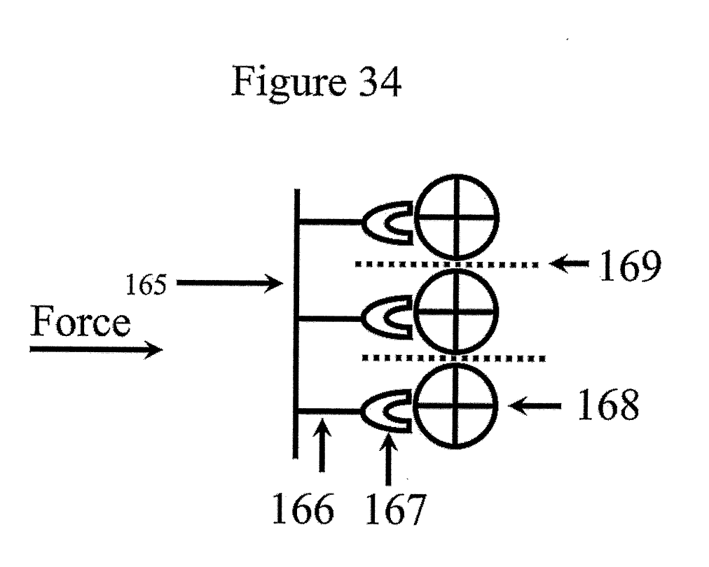

FIG. 34 is a diagram of a parallel array of magnetoclamps. Linear motion originates from (165) and pushes a holder (166) for the array of magnetoclamps (167) against a series of rotors (168). Ideally each rotor is connected to a common shaft. In the ideal embodiment, magnetic shielding (169) substantially separates each clamp-rotor set.

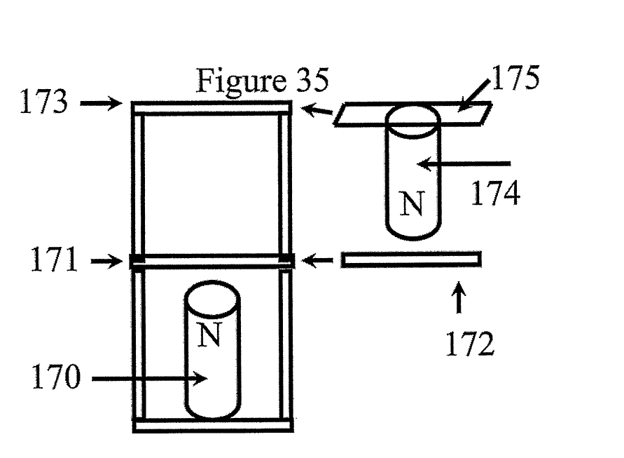

FIG. 35 is a diagram of a configuration of a magnetic generator that also makes use of gravity. The magnet parts here are shown conceptually, not necessarily in their envisioned shape. The point is that one does not require the clamp arrangement. Two separate hollow cylinders, one larger than the other, can come into proximity and cause magnetic repulsion and spin if the magnets are on the inside of the outer one and the outside of the inner one. A housing (173) consists of a first magnet set above (174) and a second one below (170) which spins and generates electricity. Above the second magnet set is an insertion point (171) for insertable/removable magnetic shielding (172) to set up the system. The first, upper magnet set is attached to a holder (175) that keeps the upper magnet set in the same plane as the first along the sides of the housing. When the magnetic shielding (172) is removed, the magnet sets approach each other and generate electricity.

A similar arrangement can be used to construct two magnet sets held in approximation by the housing. Magnetic shielding between the two magnet sets keeps the second set from spinning during set-up. Magnetic shielding can also be used to control when the system is on or off.

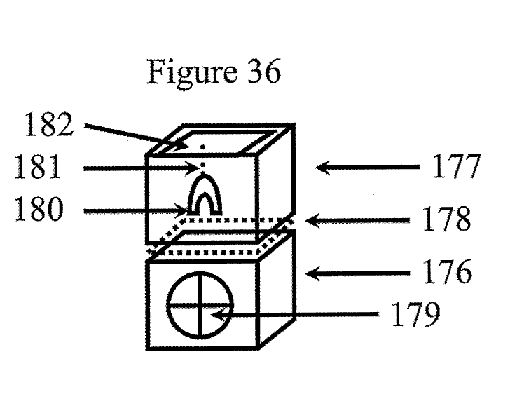

FIG. 36 is a diagram of a magnetoclamp oriented to make use of gravity. The concept is similar to that of FIG. 35 but uses a different shape of generator. (176) is the lower housing and (177) is the upper housing separated by magnetic shielding (178). (180) is the clamp—the first magnet set—and (179) is the rotor—the second magnet set. The clamp is suspended by holding piece (181) from a holder (182) that maintains the correct path of the clamp as it is lowered into proximity with the rotor. A catch point can prevent scraping of the two magnet sets.

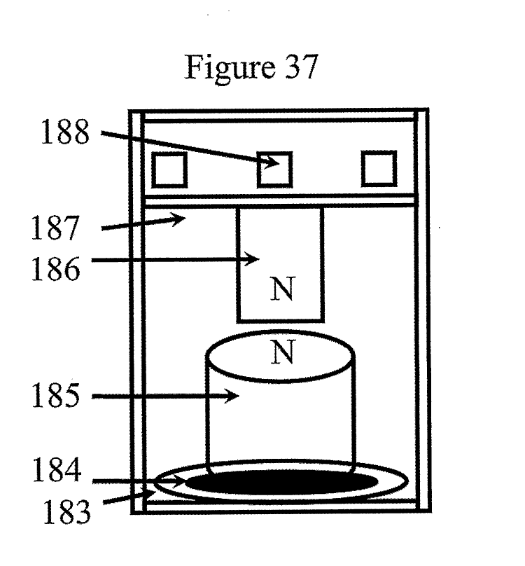

FIG. 37 is a diagram of a magnetic generator with weights. The weights (188) can be inserted and removed from the holder (187) for the first magnet set or clamp (186) to adjust the weight for maximal force. (185) is the second magnet set that spins. It can be connected to a shaft or hold magnets on the outside (184) and be surrounded by a coil (183) to generate electricity. Part of the purpose of the weights is to adjust the amount of repulsion as needed, for example, to control heat, power level, etc., and to make the generator part lighter so that, when service is needed, the weights can be removed.

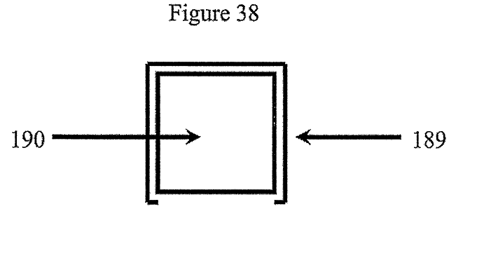

FIG. 38 is a horizontal cross-section of a magnetic generator housing. The housing (189) provides a guide for the inner holder (190) of the first magnet set to move up and down.

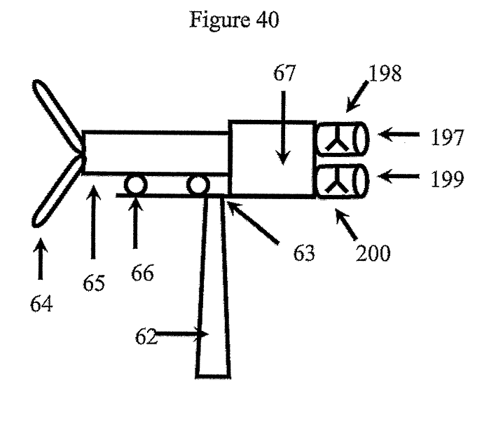

FIG. 40 is a diagram of a sail and compression chamber with inlet and outlet valves. This solution uses turbines but captures the energy with a sail, and uses a turbine internally, which is much less disturbing to the environment. As explained before, (64) is in the ideal configuration a sail driving a sliding means and piston (65) into a compression chamber (67). From there the fluid, whether liquid or gas, is forced through a valve (197) and turbine (198). In one embodiment, that valve and turbine are bidirectional. In another embodiment, (197) is an outlet valve and (199) is an inlet valve with second turbine (200). This system also enables the turbines to run at lower fluid speeds because of the concentration of exit fluid into a smaller area than that captured by the sail.

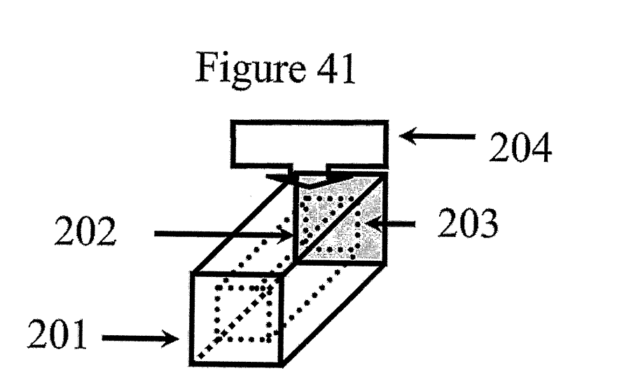

FIG. 41 is a piezoelectric energy-producing device. It also functions in a condition of limited motion. Part (201) is an exterior structure with empty volume whose inside is lined on all sides with piezoelectric material, as shown on side (203), connected to electrical current conductors. Part (202) is an interior structure with ideally solid volume, ideally of the same shape as the exterior structure but of lesser dimensions. It can function as a rattle that captures energy through any motion, including vibration. In one embodiment, it could be attached to a machine. In one embodiment and use, it could be implanted in a living being; in another, it could be placed in a laptop or other electrical device. In the case of its use in a laptop, a pressure-producing means (204) such as a plunger could be used to push the interior structure against the exterior structure as needed.

Some background points: The reasoning for the use of sails is that it may enable the availability of more energy from the mass flow. The potential energy in the sail concept emerges from the wind capture, which is meaningful when we put out a sail with a large vertical surface.

The current invention may enable the production of much more energy per area of land or sea surface. (Another advantage of the system is that it produces energy at lower wind speeds than large propeller blade structures.) Here we assume continuous force being captured, rather than gusts, but this assumption may not be true. In practice, certain of the inventions shown above may only have an application in gusty areas. Let us make rough calculations, first for a rotor system:

Air density at sea level on a cool day: 1.22 kg/cubic meter

Let's make it easier to calculate at 1.2

1 mile per hour is around 0.5 m/sec

5 mph is around 2.5 m/sec

Assume a mild wind speed of 5 mph, at which a current art propeller system won't even turn, just for the calculations.

Wind speed of 2.5 m/sec

Rotor of 20 m diameter has a surface area of 314 square meters

Mass flow=1.22×2.5×314=957.7 kg of air per sec

Propeller turbines extract 30% or less of the energy theoretically. (Betz's calculations show a maximum possible of 59%.)

Now let's calculate for the current invention of a wind sail system.

Kinetic energy is E=mvv/2

So the kinetic energy above is 957.7×2.5/2=1197 kg m/sec

Now the 20 meter diameter means that a minimum space around the propellers has to be left unused. Let's say that the total area included by the propeller based system is a percentage of 20×20=400 meters square. So the kinetic energy obtained is 1197/400=3 joules per square meter.

Compare to a sail system: 1.22×2.5×400=mass flow=1220

Kinetic energy is 1220×2.5/2=1525

Kinetic energy per square meter is 1525/400=3.8 joules per square meter per second for an area of 400 square meters.

The difference is actually much greater: Where land area is sufficient, blade turbines are spaced three to five rotor diameters apart, perpendicular to the prevailing wind, and five to ten rotor diameters apart in the direction of the prevailing wind, to minimize efficiency loss. Sails, however, can be placed adjacent to each other. That means a series of wind turbines spaced five rotor diameters apart is exposed to mass flow of about ⅗ joule per square meter per second when the total area dedicated to wind turbines is included. This comparison underestimates the difference because it only calculates the horizontal separation of bladed wind turbines, and because the difference becomes more evident at higher speeds. In addition, the sails do not miss the area between the blades, so they can be theoretically more efficient. On the other hand, with some of the configurations shown here, such as a vertical axis sail, we have to subtract ½ of the horizontal space to take the return trip into account.

Therefore if a sail operates with the same efficiency as a bladed turbine, it is a more cost effective method.

Another efficiency issue is that wind turbines hardly do anything until the wind reaches around 5-10 miles per hour. That is also incredible wasted capacity.

In another embodiment, the sail system uses transparent fabric that allows sunlight to pass through.

The electrical generating system of a wind power-generating device may consist of a one-way or two-way generator.

The concept of the different magnet generators is that one does need back and forth motion to produce energy, but that the back and forth motion exists but is unseen in the case of the magnetic generators.

While the invention has been described with respect to a limited number of embodiments, it will be appreciated that many variations, modifications and other applications of the invention may be made.

### SUMMARY OF THE INVENTION

In this section, numbers in parentheses refer to parts of the drawings.

It is now disclosed for the first time a system for the generation of energy from fluid flow, comprising: a. at least one vertical axis sail, (2, 5), b. a central rod (1) to which each sail is attached along its height, c. a generator (4), operative to produce electricity from the movement of the central rod. Note that there are vertical axis wind turbines, but not using sails because of the problem of the return journey to be dealt with as described. According to another embodiment, the fluid flow is a gas. According to another embodiment, the fluid flow is a liquid. According to still further features in the described preferred embodiments, there is provided d. a furling and unfurling means for each sail. (10-14) According to another embodiment, the sail is unfurled (2) when facing a direction of rotation consistent with the direction of the fluid flow, and furled (5) on each sail's return movement. According to still further features in the described preferred embodiments, there is provided e. a microprocessor operative to control the furling and unfurling. According to still further features in the described preferred embodiments, there is provided f. a fluid direction sensor, linked to said microprocessor, and operative to keep the sail unfurled when the sail is substantially perpendicular to the fluid flow and not on a return journey. According to still further features in the described preferred embodiments, there is provided e. a mechanical control system operative to control the furling and unfurling, wherein a mechanical connection activates the furling and unfurling. According to another embodiment, the furling and unfurling means is a pulley/drawstring/curtain device. (10-14) According to still further features in the described preferred embodiments, there is provided d. at least one side rod (3) for each sail, said side rods connected at one end to the central rod (1). According to another embodiment, each said sail is substantially rectangular. According to still further features in the described preferred embodiments, there is provided d. a side rod (10), connected to the sail, near the bottom of the external portion of the central rod (9) at substantially a right angle to the central rod, e. a platform underneath the sail, (FIG. 1, dotted lines)

f. a sliding means (16) on said side rod, operative to enable the side rod to move smoothly in contact with the platform. According to still further features in the described preferred embodiments, there is provided d. a side rod (10), connected to the sail, near the bottom of the external portion of the central rod (9) at substantially a right angle,
e. a drainage hole (15) at the bottom of said side rod. According to still further features in the described preferred embodiments, there is provided d. A blocking means outside the periphery of the sail, operative to block the fluid flow from the sail's return trip. (25a, 34, as illustrations of the concept) According to another embodiment, the blocking means is a flow deflection device.

It is now disclosed for the first time a system for the generation of energy from fluid flow, comprising: a. at least one sail (17), facing the direction of fluid flow, b. a crankshaft system (19, 20, 21) connected to a rigid portion (18) of said sail, c. a generator, operative to produce electricity from the rotation of the crankshaft system. According to another embodiment, the fluid flow is gas. According to another embodiment, the fluid flow is a liquid. According to still further features in the described preferred embodiments, there is provided d. means for adjusting the system to face the direction of fluid flow. According to still further features in the described preferred embodiments, there is provided d. a furling and unfurling means for each sail. According to another embodiment, the said means is a pulley/drawstring/curtain device. (10-14) According to another embodiment, the sail is unfurled (17) in a direction of linear motion facing the direction of the fluid flow, and furled (22) on each sail's return movement. According to still further features in the described preferred embodiments, there is provided e. a mechanical means for coordinating crankshaft movement and sail furling operative to furl the sail on its return movement. According to still further features in the described preferred embodiments, there is provided e. a microprocessor operative to control the furling and unfurling. According to still further features in the described preferred embodiments, there is provided d. at least a second sail and crankshaft in parallel with the first sail and crankshaft, wherein each set of sail and crankshaft connects to the same crank and the points of attachment (26) to the crank rod are substantially symmetrically spaced around the central crank axis. According to still further features in the described preferred embodiments, there is provided d. a microprocessor/sensor system operative to orient the system to face oncoming fluid flow. According to still further features in the described preferred embodiments, there is provided d. A blocking means operative to block the fluid flow from the sail's return trip. (25a) According to another embodiment, the blocking means is a flow deflection device.

It is now disclosed for the first time a system for capturing energy from fluid flows, comprising: a. a sail, facing the direction of fluid flow, b. a generator, c. an unfurling means operative to unfurl the sail in the direction of the fluid flow and a furling means for the sail's return journey. (FIGS. 3, 5)

It is now disclosed for the first time a system for a vertical axis sail energy capture machine, comprising: a. a generator (28), b. a central pole (29), c. an interior sail (31) connected to the central pole along its height and facing a fluid flow, d. a hinge (33), e. an exterior sail (32) connected to the other side of the first sail by means of a hinge, said hinge opening no more than 180 degrees in an arc that moves from the interior sail in the direction of oncoming fluid flow. According to another embodiment, the fluid flow is a gas. According to another embodiment, the fluid flow is a liquid. According to still further features in the described preferred embodiments, there is provided f. a microprocessor operative to control the swinging of the hinge. According to still further features in the described preferred embodiments, there is provided g. a fluid direction sensor, linked to said microprocessor, and operative to keep the sail unfurled when the sail is substantially perpendicular to the fluid flow. According to still further features in the described preferred embodiments, there is provided f. a mechanical control system operative to control the hinge's opening and closing. According to still further features in the described preferred embodiments, there is provided f. A blocking means operative to block the fluid flow from the sail's return trip. (34) According to another embodiment, the blocking means is an aerodynamically shaped flow deflection device. According to still further features in the described preferred embodiments, there is provided f. a side sail (35) fixedly attached to the exterior sail along its inner support on its height on the side opposite from where the hinge opens and closes, said side sail smaller in width than the exterior sail. According to still further features in the described preferred embodiments, there is provided f. a plurality of sails attached to the central pole.

It is now disclosed for the first time a system for capturing fluid flow from wind, comprising: a. a drum (44), circular in its cross-section, in a horizontal axis, b. a guide (45), directed radially from the center of said drum, c. at least one paddle (46) extending from the drum, said paddle able to move radially in said guide. According to another embodiment, the paddle is a sail. According to still further features in the described preferred embodiments, there is provided d. a shaft, connected to said drum, e. a generator, operating from the rotation of the shaft.

It is now disclosed for the first time a system for capturing fluid flow, comprising: a. a rod (47a), circular in its cross-section, in a horizontal axis, b. a sail frame (47), attached to and directed radially from the center of said rod, c. a sail (48, 49) extending from the rod and capable of sliding in said frame. According to still further features in the described preferred embodiments, there is provided d. a generator (51), operative to produce electricity from the rotation of the rod. According to still further features in the described preferred embodiments, there is provided d. a plurality of sail frames and sails. According to still further features in the described preferred embodiments, there is provided d. a blocking means (48a) operative to block the fluid flow in the direction of the sail's return trip. According to another embodiment, the blocking means' lowest point is at least at the height of the highest part of the sail when the sail is radially directed at a right angle to the ground. According to another embodiment, the blocking means is a flow deflection device.

It is now disclosed for the first time a blade (53), comprising: a. a peripheral at least one side arm (54) appended to the blade, b. a substantially flat panel (55) attached to said side arm or arms, whose cross-section is perpendicular to the circular movement of the blade. According to another embodiment, the blade is a sail. According to another embodiment, the panel is a sail. According to another embodiment, the blade is attached to an energy capture device.

It is now disclosed for the first time a sail for an energy capture system of a fluid flow, comprising: a. an external rigid frame, b. a flexible interior material (58) within and attached to the frame, said sail not being substantially flat in a plane. According to another embodiment, said interior is not tense within the frame (57). According to another embodiment, said interior is tense within the frame. According to another embodiment, said interior's plane twists at least 15 degrees. According to another embodiment, said interior assumes the shape of a streamlined object when subjected to fluid flow. According to another embodiment, said interior assumes the shape of a streamlined object when subjected to fluid flow in at least two substantially opposite directions. According to another embodiment, the fluid flow is liquid. According to another embodiment, the fluid flow is a gas.

It is now disclosed for the first time an energy capture system, comprising:

a. an automatic regreaser means for the moving components.

It is now disclosed for the first time a fluid flow energy capture system, comprising: a. at least one rigid extension (59) operative to rotate around a central hub, b. a sail connected to said extension (60, 61), c. a generator operative to produce electricity from the rotation of the hub, d. a support system for said hub, said hub capable of horizontal movement. According to another embodiment, the extension connects to the interior of the sail. According to another embodiment, the extension connects to the exterior of the sail. According to another embodiment, the width of the sail is at least one-fifth of the distance from the periphery of the outer extensions to the hub.

It is now disclosed for the first time a system for the capture of energy, comprising: a. a sliding means operating from and transferring an input of renewable linear energy (62, 63, 65, 66, 111), b. a means of arrest or resistance for the movement of the sliding means at a defined range of points, (shown conceptually by 67) c. an energy conversion means for converting the linear movement of the sliding means into output energy, said sliding means capable of providing new energy at least a second time without the addition of energy to return the sliding means. (FIGS. 21-25) Nonrenewable sources are, for example, substances providing energy when burnt, such as oil, coal, and nuclear. The input of renewable linear energy is emphasized as the input, because it is unique. “Addition of energy” refers to energy expended on returning the energy capture component that is not produced by the system described here. According to another embodiment, the input energy is a fluid flow. According to another embodiment, the fluid flow is a gust. According to another embodiment, the gust is wind. According to another embodiment, the input energy is gravitation. According to another embodiment, the energy input is substantially horizontal. According to another embodiment, the energy input is substantially vertical. According to another embodiment, the energy input is substantially continuous. According to still further features in the described preferred embodiments, there is provided d. a panel (64, 109) facing the direction of fluid flow, said panel attached to the sliding means. According to another embodiment, the panel is a sail. (64, 69) According to still further features in the described preferred embodiments, there is provided

d. a piston (70, 90) attached to the sliding means, e. a chamber (67, 71, 112) as the energy conversion means, in linear relationship to said piston, operative to produce energy from the force of said piston. According to another embodiment, said chamber contains a gas. (112) According to another embodiment, said chamber contains a piezoelectric material (87). According to another embodiment, said chamber further comprises: f. an air inlet and outlet, located between the piston and the end of the chamber. According to still further features in the described preferred embodiments, there is provided
d. a magnet set attached to the sliding means. According to another embodiment, the energy conversion means is a magnet set (100). According to another embodiment, the energy conversion means is a coil (101). According to still further features in the described preferred embodiments, there is provided d. a gear set attached to the sliding means. According to another embodiment, the energy conversion means is a gear set. According to another embodiment, the energy conversion means is a nanomaterial. According to still further features in the described preferred embodiments, there is provided d. a coupling attached to the sliding means. According to another embodiment, the means of arrest is a stop point to the sliding means. According to another embodiment, the means of arrest is air pressure. According to another embodiment, the means of arrest is magnetism. According to another embodiment, the output energy is electrical. According to another embodiment, the output energy is rotational motion. According to another embodiment, the output energy is heat. (92) According to another embodiment, the output energy is compressed air. (FIG. 24) According to another embodiment, the output energy is piezoelectric current. (87) According to another embodiment, the output energy is mechanical. (FIG. 24) According to still further features in the described preferred embodiments, there is provided d. a Bourdon tube, operative to produce mechanical energy. (115, 116, 119, 120)

It is now disclosed for the first time a wind energy capture system, comprising: a. a sail system, including at least one sail, b. at least one common piece to which all parts of the sail system are connected, c. said common piece moves substantially parallel to the direction of the wind, said object operating to translate wind energy into linear mechanical energy, d. said common piece provides force to a fixed-location energy capture system, fixed in location in the same direction as the wind, with said central object capable of moving closer to or farther from the energy capture system. According to another embodiment, the sail system is rectangular, with the greater length in a vertical direction. According to still further features in the described preferred embodiments, there is provided e. at least one cross-connection, tightly connecting at least two points of two masts substantially near the periphery. (74, 77) According to still further features in the described preferred embodiments, there is provided cross-connections connecting at least four points on the periphery located no less than 90 degrees of arc from each other. (80) According to still further features in the described preferred embodiments, there is provided e. a generator operating from the linear motion of the common piece. According to another embodiment, said central piece rotates on its axis. (64, 65) According to still further features in the described preferred embodiments, there is provided e. a generator connected to the rotation of the common piece.

It is now disclosed for the first time an umbrella, comprising: a. at least one cross-connection connecting at least two points substantially near the periphery of the radial supports, said cross-connection being substantially tight when the umbrella is opened. According to still further features in the described preferred embodiments, there is provided b. cross-connections connecting at least four points on the periphery located no less than 90 degrees of arc from each other.

It is now disclosed for the first time a fluid flow energy capture system, comprising: a. at least two hollow rigid blades with a non-rigid sail-like material, attached to the hollow interior of said blades, b. a central hub to which said blades are attached, c. a moveable structure to which said hub is attached, said moveable structure moving in parallel with the fluid flow on any of the group of slides, bearings, or wheels. According to still further features in the described preferred embodiments, there is provided a generator driven by the rotation of said blades. According to still further features in the described preferred embodiments, there is provided a generator driven by the linear motion of said moveable structure.

It is now disclosed for the first time a two-way energy capture system, comprising: a. a means for capturing linear force from two different directions, (102-104) b. a central moveable structure (106), mounted so as to move in at least two different directions, and attached to the means for capturing linear force so that each linear force is substantially parallel to each of the structure's directions, c. a generator system (107) at the end of each of the moveable structure's directions. According to another embodiment, the means of capture is a sail. According to another embodiment, the central moveable structure contains at least one magnet that induces electricity in the generator system. According to another embodiment, the generator system operates by compressed air. According to another embodiment, the generator system operates by piezoelectricity.

It is now disclosed for the first time a system for capturing energy from gusts of fluid flow, comprising: a. a sliding means moving in a horizontal direction whose motion is arrested at a defined set of points, said sliding means absorbing energy from a sail.

It is now disclosed for the first time a system for capturing energy from linear motion, comprising: a. a sliding means moving in a horizontal direction whose motion is arrested at a defined set of points, said sliding means absorbing energy from a sail.

It is now disclosed for the first time a pendulum, comprising: a. a first vertical side (122) with a polygonal surface area, b. a second vertical side with a polygonal surface area, c. at least a third vertical side with a polygonal surface area, d. attachments between the side edges of each side, wherein the vertical sides and attachments approximate a 360 degree circuit among the sides, and wherein each side is flat or concave, e. a shaft (123) connecting the top (defined as referring to either the top or bottom in any orientation) in the central axis of the pendulum to a ball and socket (125, 125a, 125b) on the other side. According to another embodiment, the horizontal sides (121) are enclosed. 118. The pendulum of claim 116, wherein at least one of the sides is a sail. According to still further features in the described preferred embodiments, there is provided f. a side piece (124) attached to the shaft between the pendulum and the socket, said side piece wider than the opening in the socket. According to still further features in the described preferred embodiments, there is provided f. an attachment (shown conceptually by 126) to the ball, said attachment producing energy by its motion within a generating system. According to another embodiment, it is placed in a gaseous environment. According to another embodiment, it is placed in a liquid environment. According to another embodiment, the socket consists of a circumferential band, from the median horizontal line partially down and up, around said ball. According to another embodiment, the pendulum is placed in an area of walls which produce electricity by the impact of the pendulum on the walls.

It is now disclosed for the first time a pendulum system, comprising: a. a ball (125) with an vertical shaft (123) connected to a weight-bearing object, b. a socket (125b) for said ball consisting of a circumferential band apposed to said ball, said band extending partially above and below the median horizontal line.

It is now disclosed for the first time a wind energy capture system, comprising: a. a sliding device translating wind force into substantially horizontal movement, (98) b. at least one magnet set connected to said device. (99) According to still further features in the described preferred embodiments, there is provided c. at least a second magnet set in electromagnetic proximity to the first magnet set. (101) According to still further features in the described preferred embodiments, there is provided d. First and second magnet sets having similar polarities facing each other.

It is now disclosed for the first time a system of generating energy, comprising: a. a first magnet set (128, 135) with at least one individual magnet, b. a second magnet set (132) with at least one individual magnet in electromagnetic congruity to the first magnet set, wherein the polarity of each magnet of the first magnet set faces the same polarity of each magnet in the second magnet set, c. a rotor (131, 136), holding the second magnet set, said rotor connecting to a generator component that produces electricity as it spins. According to another embodiment, the generator component is a shaft (133, 137), connected to the rotor on one end (133) and on the other to a generator. According to another embodiment, the generator component is a third magnet set (184), connected to the rotor, said third magnet set being adjacent to a coil (183) and operative to produce electricity. According to another embodiment, the second magnet set is in the same axis as the first. According to another embodiment, the second magnet is in a perpendicular axis to the first magnet set. According to another embodiment, the first magnet set directs linear force towards the second magnet set. According to another embodiment, the magnets on at least one of the magnet sets are angled towards magnets on the other magnet set in a single direction of spin of the second magnet set. (152) According to still further features in the described preferred embodiments, there is provided d. a means for inserting and removing an electric shield between the two magnet sets. (171, 172) According to still further features in the described preferred embodiments, there is provided d. a housing that holds the two magnet sets at a fixed distance. (176, 177) According to still further features in the described preferred embodiments, there is provided d. a housing that holds the second magnet superior to the first magnet set at a variable distance. (187) According to still further features in the described preferred embodiments, there is provided e. weights (188) placed superior to the first magnet set and applying weight to the first magnet set. According to still further features in the described preferred embodiments, there is provided the direction of linear motion of the first magnet set is towards the force of gravity. (FIGS. 35, 36, 37) According to still further features in the described preferred embodiments, there is provided a housing that holds the second magnet set horizontal to the first magnet set at a variable distance. According to still further features in the described preferred embodiments, there is provided d. a housing for said magnet sets, said housing operative to prevent the magnet sets from moving away from each other. (176, 177)

It is now disclosed for the first time a magnetic generator, comprising: a. a first magnet set (146, 147) mounted on a first structure (145), b. a second magnet set (148, 149) mounted on a rotor, the second magnet set being in electromagnetic proximity to the first magnet set, said electromagnetic proximity consisting of repelling magnets facing each other, the magnets on at least one set oriented at an angle of repulsion in one rotational direction on the rotor. (151, 152) According to still further features in the described preferred embodiments, there is provided c. shielding means (146, 148) to hide the attractive sides of the magnets between the first and second magnet sets. According to another embodiment, the first and second magnet sets have magnets arranged in pie-shaped segments with the tip of the pie in the center. (146-149) According to another embodiment, the first and second magnet sets have magnets arranged in radial strips. (154, 194-196) According to another embodiment, the outer surfaces of at least one of the magnet sets comprise alternating pie-shaped pieces of one repelling type (North or South) and shielding. (146-149) According to another embodiment, the first magnet set at least partially surrounds the rotor on two sides along the planar surfaces of the rotor. (145) According to still further features in the described preferred embodiments, there is provided d. an energy capture device (127, 144), connected to the first magnet set and operative to push the first magnet set towards the second magnet set. According to another embodiment, the energy capture device is a sail. According to another embodiment, the energy is wind. According to another embodiment, the pushing is perpendicular to the plane of the rotor. (FIG. 33 b, c, d) According to another embodiment, the pushing is parallel to the plane of the rotor. (FIG. 33a)

It is now disclosed for the first time a magnetic generator system, comprising:

a. a first magnet set with at least one individual magnet, (174, 186) b. a second magnet set (170, 185), with at least one individual magnet in electromagnetic congruity to the first magnet set, wherein the polarity of each magnet of the first magnet set faces the same polarity of each magnet in the second magnet set, c. a removable shield between the first and second magnet set, (172) d. a generating system connected to second magnet set. (183, 184) According to still further features in the described preferred embodiments, there is provided e. magnetic shielding on all other sides of the two magnet sets.

It is now disclosed for the first time a magnetic clamp generator, comprising: a. a first magnet set in the shape of a clamp, b. a second magnet set in a rotor, capable of rotating in the middle of said clamp, with at least one individual magnet in electromagnetic congruity to the first magnet set, wherein the polarity of each magnet of the first magnet set faces the same polarity of each magnet in the second magnet set. According to another embodiment, the magnets on at least one of the magnet sets are angled towards the magnets on the other magnet set in one rotational direction on the rotor. According to still further features in the described preferred embodiments, there is provided c. a shaft (137) connected to the center of said rotor, said shaft operative to produce electricity by its rotation. According to still further features in the described preferred embodiments, there is provided (c) a set of coils (138) adjacent to the rotor, said coils operative to produce electricity by the rotation of the rotor.

It is now disclosed for the first time a magnetic generator system, comprising: a. a plurality of magnetic generators in tandem (167, 168), each rotor (168) of which is connected to a central rotating shaft. According to still further features in the described preferred embodiments, there is provided b. magnetic shielding substantially separating each generator. (169)

It is now disclosed for the first time a magnetic generator system, comprising:

a. a first magnet set with at least one individual magnet, b. a second magnet set on a rotor, with at least one individual magnet in electromagnetic congruity to the first magnet set, wherein the polarity of each magnet of the first magnet set faces the same polarity of each magnet in the second magnet set, c. a means for pushing the first magnet set into greater proximity with the second as the force on the first magnet set increases. (139, 140)

It is now disclosed for the first time a magnetic generator system, comprising:

a. a first magnet set with at least one individual magnet, (145) b. a second magnet set on a rotor, in electromagnetic proximity to the first magnet set, c. at least one of the magnets of the first magnet set has the same facing polarity as the second magnet set and has an angle in respect to the plane of the rotor. (148, 149) According to another embodiment, all magnets have the same angle in the same direction.
It is now disclosed for the first time a magnetic generator system, comprising:
a. a first magnet set with at least one individual magnet, b. a second magnet set on a rotor, in electromagnetic proximity to the first magnet set, c. at least one of the magnets of the second magnet set has the same facing polarity as the first magnet set and has an angle in respect to the plane of the rotor. (FIG. 32) According to another embodiment, all magnets have the same angle in the same direction of the rotor's rotation. That means that they are operative to create motion in one direction.

It is now disclosed for the first time a magnetic generator system, comprising:

a. a first magnet set with at least one individual magnet, b. a second magnet set on a rotor, in electromagnetic proximity to the first magnet set, c. at least one of the magnets of the second magnet set has the same facing polarity as the first magnet set and both magnets have an angle in respect to the plane of the rotor. According to another embodiment, all magnets have the same angle in the same direction of the rotor's rotation. That means that they are operative to create motion in one direction.

It is now disclosed for the first time a generator system, comprising: a. a means of linearly directed force, (144, 153) b. a first magnet set with at least one individual magnet, said set attached to said means of linear force, c. a second magnet set in a rotor, in electromagnetic proximity to the first magnet set, wherein the first and second magnet sets have the same facing polarity, said rotor possessing a central axis hub or shaft, d. a catch (150) to the means of linear forces that stops the first magnet set's movement towards the rotor before contacting the hub or shaft of the rotor. According to another embodiment, the first magnet shape is a clamp around the first. According to another embodiment, the first magnet shape is located between two parallel rotors. According to another embodiment, the first magnet shape is a half circle. (145) According to another embodiment, at least one magnet from at least one of the magnet sets is set at an angle to the plane of the rotor.

It is now disclosed for the first time a magnetic generator system, comprising:

a. a first magnet set with magnet sets on both sides, (142, 143) b. two second magnet sets on two rotors, in electromagnetic proximity to the first magnet set on each side, c. at least one of the magnets of the first magnet set has the same facing polarity as the second magnet set on each side of the first magnet set and has an angle in respect to the plane of the rotor. (148, 149)

It is now disclosed for the first time a structure of at least two surfaces, comprising: a. a magnet set of at least one magnet attached to the structure on one side from the direction of the center towards the direction of the periphery, each magnet separated by a non-magnetic area. (FIG. 39) According to another embodiment, the magnet set contains at least two magnets. According to another embodiment, the magnet set contains at least three magnets. According to another embodiment, the structure is circular. (179, 192, 193) According to another embodiment, the structure is substantially semi-circular. (145) According to another embodiment, the non-magnetic area is magnetically shielded. (FIG. 33) According to another embodiment, each magnet on one side has the same polarity facing outward from the structure (FIG. 39) According to another embodiment, each magnet on one side is angled in the same direction from the plane of the structure. According to another embodiment, each side of the structure has a magnet set. According to another embodiment, the direction of each magnet's angling on one side is symmetrical to the other side. According to another embodiment, the structure is attached to a shaft. (155) According to another embodiment, each magnet is angled above the plane of the structure (FIG. 32, 39) According to another embodiment, the magnets are substantially polygonal. (194) According to another embodiment, the magnetic and non-magnetic areas are substantially pie-shaped (FIG. 32, 39) According to another embodiment, the structure is substantially rectangular. (190) According to another embodiment, the magnets on a magnet set are symmetrically placed.

It is now disclosed for the first time a magnetic generator, comprising: a. a first magnet set with at least one individual magnet, b. a second magnet set, with at least one individual magnet in electromagnetic congruity to the first magnet set, wherein the polarity of each magnet of the first magnet set faces the same polarity of each magnet in the second magnet set, c. at least one magnet set is operative to spin from the proximity of the two magnet sets.

It is now disclosed for the first time a clamp-shaped generation system, comprising: a. A magnet set with at least one magnet on one inner side of the clamp, b. A magnet set with at least one magnet on the other inner side of the clamp, c. a space between the inner sides, d. wherein each magnet set has a single polarity facing the inner side of the clamp. According to still further features in the described preferred embodiments, there is provided e. a rotor with a magnet set on at least one side in the inner space, each magnet of the magnet set having a single polarity similar to that of the clamp's magnet set on that side. According to another embodiment, the rotor's magnets are radially aligned. According to another embodiment, at least one of the magnet sets on the clamp or the rotor are angled in the same direction.

It is now disclosed for the first time a method of creating rotational motion from linear motion, wherein two magnet sets, one of which is located on a rotatable structure, each magnet set facing the same polarity, are brought into electromagnetic contact. According to another embodiment, locking of the magnets is prevented by shielding. According to another embodiment, locking of the magnets is prevented by angling the magnets. According to another embodiment, angling of the magnets of at least one of the two magnet sets creates rotational motion. According to another embodiment, a linear force is applied to one of the magnet sets.

It is now disclosed for the first time a method of capturing fluid energy, comprising: a. furling an unfurled sail on its return trip to the point of energy capture and unfurling it for points of energy capture. According to another embodiment, a microprocessor controls furling and unfurling of the sail. According to another embodiment, a sensor provides the microprocessor with information on the direction of energy flow.

It is now disclosed for the first time a method of manufacturing electricity, comprising: the creation of smooth rotational motion from linear motion by the electromagnetic apposition of magnets of repulsive charge.

It is now disclosed for the first time a sail rotating on a rod in a vertical axis, comprising: a. a side extension (10) mounted on sliding means (16), operative to support the side extension and the sail.

It is now disclosed for the first time a method of enabling reduced friction return motion for a sail, comprising: a. a flow deflection device that is placed between the fluid flow and the return motion of the sail.

It is now disclosed for the first time a fluid flow energy farm, comprising: a. at least two sails on adjacent machines, each sail forming an arc with a vertical axis in the direction of fluid flow. (74)

It is now disclosed for the first time a method of preventing flipping of structure with a frame with a flexible interior, comprising: a. providing crossbeam structures from the periphery of the structure to another periphery of the structure. (FIG. 17)

It is now disclosed for the first time a system of sails, comprising: a. modular polygonal sails with connection means at their edges.

It is now disclosed for the first time a method of producing renewable energy, comprising: a. using gravity as a linear force.

It is now disclosed for the first time a method of producing renewable energy, comprising: a. using magnetism as a linear force.

It is now disclosed for the first time a system for the capture of energy, comprising: a. a sliding means operating from and transferring an input of linear energy from a fluid, (64) b. a piston attached to the sliding means, (65) c. a compression chamber (67) operating from compression by the piston, in linear relationship to said piston, d. a first fluid valve (197) at the side of the chamber opposite to the piston, e. a turbine (198) attached to said fluid valve, operative to produce energy from the movement of fluid through the fluid valve. According to another embodiment, the turbine is bidirectional. According to another embodiment, the first air valve is a unidirectional outlet, and further comprising, on the side of the chamber opposite the piston, a second unidirectional inlet fluid valve (199) with an attached turbine. (200) According to another embodiment, the energy input is from a sail. According to another embodiment, the fluid is a gas. 216. The system of claim 211, wherein the fluid is a liquid.

It is now disclosed for the first time a generator, comprising: a. a three dimensional shape, forming a housing on its outer side, (201) b. piezoelectric layers (203) attached to the interior of said housing, said layers connected to an electric current producer, c. a second three-dimensional shape (202), smaller than the first shape and its piezoelectric layers, in at least one dimension, said second shape not attached to the piezoelectric layers. According to another embodiment, the inner and outer shapes have the same ratios of their dimensions. According to another embodiment, the inner shape is smaller in all dimensions. According to another embodiment, a means for providing pressure into the generator system is attached. According to still further features in the described preferred embodiments, there is provided d. a plunger, operative to move the second shape against the piezoelectric layer of the first. According to another embodiment, the generator is implanted into a living being. According to another embodiment, the generator is attached to a source of vibration.

1-222. (canceled)

223. A system for the generation of energy from fluid flow, comprising:
a. at least one sail,
b. a central rod to which each sail is attached along its length,
c. a generator, operative to produce electricity from the rotation of the central rod.
d. a furling and unfurling means for each sail, wherein the sail is substantially fully unfurled when perpendicular to a direction of the fluid flow, and furled on each sail's return movement.

224. The system of claim 223, further comprising:
e. a platform or track underneath the sail,
f. a sliding means, operative to support the sail on the platform or track.

225. A system for the generation of energy from fluid flow, comprising:
a. at least one sail, facing a direction of fluid flow,
b. a crankshaft system connected to a rigid portion of said sail,
c. a generator, operative to produce electricity from the rotation of the crankshaft system.
d. a furling and unfurling means for each sail, wherein the sail is unfurled in a direction of linear motion parallel to the direction of the fluid flow, and furled on each sail's return movement.

226. A vertical axis sail system for an energy capture machine, comprising:
a. a generator,
b. a central pole,
c. an interior sail connected to the central pole along its height and facing a fluid
flow,
d. a hinge,
e. an exterior sail connected to the other side of the first sail by means of a hinge, said hinge opening no more than 180 degrees in an arc that moves from the interior sail in the direction of oncoming fluid flow.

227. A system for capturing fluid flow, comprising:
a. a rod, circular in its cross-section, in a horizontal axis,
b. a sail frame, attached to and directed radially from the center of said rod,
c. a sail extending from the rod with means for sliding in said frame.

228. An x-axis fluid flow energy capture system, comprising:
a. at least one sail operative to rotate around a central hub in a horizontal axis,
b. a generator operative to produce electricity from the rotation of the hub,
c. a support system for said hub, said support system comprising means for x-axis movement.

229. A system for the capture of energy, comprising
a. a main piece with sliding means operating from an input of substantially linear motion and moving linearly,
b. a means of arrest or resistance for the movement of the main piece at a defined point or range of points,
c. an energy conversion means for converting the linear movement of the main piece into output energy, said means capable of providing new motion at least a second time without the addition of energy that at least partly returns the sliding means.

230. The system of claim 229, further comprising:
d. a sail system facing the direction of fluid flow, said sail connected to the main piece.

231. The system of claim 229, further comprising:
d. a compression chamber absorbing the impact of the main piece.

232. The system of claim 229, wherein the main piece pushes against a piezoelectric material.

233. The system of claim 229, further comprising:
d. a magnet set attached to the main piece.

234. The system of claim 229, further comprising:
d. a gear set attached to the main piece.

235. The system of claim 229, further comprising:
d. a coupling attached to the main piece.

236. The system of claim 229, further comprising:
d. a Bourdon tube, operative to produce mechanical energy from movement of the main piece.

237. A two-way energy capture system, comprising:
a. a means for capturing linear force from two different directions,
b. a central moveable structure, mounted so as to move in at least two different directions, and attached to the means for capturing linear force so that each linear force is substantially parallel to each of the structure's directions,
c. a generator system operating for each direction of the moveable structure.

238. The system of claim 237, wherein the means of capture is a sail.

239. A pendulum, comprising:
a. a first vertical side with a polygonal surface area,
b. a second vertical side with a polygonal surface area,
c. at least a third vertical side with a polygonal surface area,
d. attachments between the side edges of each side, wherein the vertical sides and attachments approximate a 360 degree circuit among the sides, and wherein each side is flat or concave to the outside,
e. a shaft connecting the central axis of the pendulum to a ball and socket on the other side.

240. The pendulum of claim 239, further comprising:
f a piece attached to the shaft between the pendulum and the socket, said piece wider than the opening in the socket.

241. The pendulum of claim 239, further comprising:
f. an attachment to the ball, said attachment operative to move within a generating system.

242. The pendulum of claim 239, wherein the socket consists of a circumferential band, from the median horizontal line partially down and up, around said ball.

243. A pendulum system, comprising
a. a ball with an vertical shaft connected to a weight-bearing object,
b. a socket for said ball consisting of a circumferential band apposed to said ball, said band extending partially above and below the median horizontal line.

244. A system of generating energy, comprising:
a. a main piece, with a sliding means, operative to move linearly,
b. a first magnet set, connected to said main piece, with at least one individual magnet,
c. a second magnet set with at least one individual magnet in electromagnetic proximity to the first magnet set, wherein initially the polarity of each magnet of the first magnet set faces the same polarity of each magnet in the second magnet set, and wherein the second magnet set is not attached to the main piece and does not move linearly from the approach of the main piece,
d. a rotor, holding the second magnet set, said rotor connecting to a generator component that produces electricity as it spins.

245. The system of claim 244, wherein the magnets on at least one of the magnet sets are angled towards magnets on the other magnet set in a single orientation in respect to the plane of the rotor.

246. The system of claim 244, further comprising:
d. a means for inserting and removing magnetic shielding between the two magnet sets.

247. The system of claim 244, wherein the first magnet set is superior to the second magnet set.

248. The system of claim 244, wherein the first and second magnet sets comprise magnets arranged in radial strips separated by non-magnetic areas.

249. The system of claim 244, wherein the first magnet set at least partially surrounds the rotor on two sides along the planar surfaces of the rotor.

250. A magnetic clamp generator, comprising:
a. a clamp shape, comprising a first magnet set,
b. a rotor comprising a second magnet set, said rotor capable of rotating in the middle of said clamp, with at least one individual magnet in electromagnetic congruity to the first magnet set, wherein the polarity of each magnet of the first magnet set approaches the same polarity of each magnet in the second magnet set.
c. a shaft connected to the center of said rotor, said shaft operative to produce electricity by its rotation.

251. The generator of claim 250, wherein the magnets on at least one of the magnet sets are angled towards the magnets on the other magnet set in one orientation on the rotor.

252. A magnetic generator system, comprising:
a. a first magnet set with at least one individual magnet,
b. a second magnet set on a rotor, in electromagnetic proximity to the first magnet set, said rotor connected to a generator, wherein at least one of the magnets of the first magnet set has the same polarity facing the second magnet set.

253. The system of claim 252, wherein all magnets have the substantially same angle in respect to the plane of the rotor in the same polar orientation.

254. A generator, comprising:
a. a three dimensional shape, forming a housing on its outer side,
b. at least one piezoelectric layer attached to the interior of said housing, said layer connected to an electric current producer,
c. a second three-dimensional shape, smaller than the first shape and its piezoelectric layer, in at least one dimension, said second shape not attached to the piezoelectric layers and located interior to the first shape.

255. A method of creating electricity from linear motion, comprising:
a. providing a first magnet set,
b. providing a second magnet set, located on a rotatable structure, with each magnet set facing the other with same polarity, wherein the two magnet sets are brought into electromagnetic contact.

256. The method of claim 255, wherein one magnet set is superior to the second.

257. The method of claim 255, wherein the first magnet set is connected to a source of linear motion.

258. A method of capturing fluid energy, comprising:
a. furling an unfurled sail on its return trip to the point of energy capture and unfurling it for points of energy capture.
